(19) United States
(12) Patent Application Publication
(10) Pub. No.: US 2004/0174770 A1
(43) Pub. Date: Sep. 9, 2004

(54) Gauss-Rees parametric ultrawideband system

(76) Inventor: Frank L. Rees, Windsor Mill, MD (US)

Correspondence Address: PETER K. TRZYNA, ESQ., P O BOX 7131, CHICAGO, IL, 60680, US

(21) Appl. No.: 10/722,648

(22) Filed: Nov. 25, 2003

Related U.S. Application Data
(60) Provisional application No. 60/429,763, filed on Nov. 27, 2002.

(51) Int. Cl. G03B 42/06

(52) U.S. Cl. 367/7

(57) ABSTRACT

The Gauss-Rees waveform has many applications including use in a method for identifying an object, the method including the steps of: directing a primary acoustic waveform at the object to produce a nonlinear acoustic effect; receiving a secondary wavelet produced by the nonlinear effect; and processing the received secondary wavelet in identifying the object. The object is identified by composition, image, and preferably both. The object can be concealed in a container, underground, under water, or otherwise.

### I. PRIORITY STATEMENT

This patent application is a continuation-in-part, claiming priority from, and incorporating by reference, U.S. Ser. No. 60/429,763, filed Nov. 27, 2002 by the same inventor, as well as the same benefit and incorporation of PTO Disclosure Document 503900, filed Jan. 22, 2002.

### II. BACKGROUND OF THE INVENTION

A. Technical Field of the Invention

The present invention pertains to a computer machine, manufacture, methods of making and using the same, and product produced thereby, as well as necessary intermediates, each pertaining to the Gauss-Rees parametric ultrawideband system that is discussed further below.

B. Background of the Invention

To illustrate the challenges of identifying an unknown object, consider the task of finding lethal materials of mass destruction, explosives, narcotics, or other dangerous, contraband, legally prohibited items or any other material designated. Consider a more practical challenge of finding such an object when it is concealed in some container. One known approach, Vehicle and Container Inspection System (VACIS), involves evacuating the vehicle to remove personnel while scanning the vehicle or container on a vehicle to protect the personnel from harmful ionizing radiation—e.g., X-rays, Gamma-rays, thermal or fast pulsed neutrons—involved in penetrating the vehicle or container walls. Endeavoring to extend even this problematic form of non-intrusive, remote sensing to, say, effectively scan up containers on a 700 foot long cargo-container ship is a gargantuan undertaking. Even more so, this task is daunting when the desire is to intercept such a vessel while it is underway at an adequate distance from its port of destination. Furthermore, all of the problems associated with protecting the crew from exposure to ionizing radiation has posed a problem that has escaped any easy solution. Even so, the effectiveness of such an approach in detecting low atomic-number materials is questionable. In addition, any such approach must be tempered by cost. As per the old adage, “it is like trying to find a needle in a haystack.”

Ultra-Wide Band (UWB) radar has been suggested as a possible solution. Unfortunately, its ability to only examine the morphology of the cargo involves examining numerous container-cargo “images,” generally, without the benefit of 3-D tomography afforded certain forms of airport luggage interrogation. Also, UWB radar has severe losses due to “skin-effect” currents in conducting materials—the UWB can only penetrate non-metallic portions of walls and other objects; which, apparently, is a limitation also besetting its use for ground penetration.

Other approaches, such as metal detectors, are quite limited in what can be detected: metal. Yet other approaches are practically unworkable. Of course one cannot submit everything coming into a country to chromatography, for example, in a search for ingredients for a “dirty bomb.”

Suffice it to say that the need for identifying objects, especially objects concealed in one way or another, is so grave as to be a national security issue. And while many have tried to find a viable way to meet this need, there has been no clear success.

### III. SUMMARY OF THE INVENTION

Most respectfully, it is believed that the present invention is suitable for addressing such problems. More particularly, the present invention involves discovery of a new waveform hereby named a Gauss-Rees waveform, which is discussed more thoroughly below.

Generally, however, the Gauss-Rees waveform can be used to facilitate Non-Linear Sonic (NLS) methods that rely on certain facets of the physics of nonlinear acoustics. The departure facilitated by the Gauss-Rees waveform into nonlinear acoustics is an advance over linear (so-called “small-signal fluctuation”) approaches, at least in that it has been discovered that the elastic scattering properties of sonic-propagation media change as pressure-fluctuation induced stresses are increased. Notably, the speed-of-sound in a material (such as air) depends upon the square root of the ratio of the bulk modulus (or its equivalence in terms of elastic-material constants) and the density of the material. Both of these material parameters change as significant pressure space and time variations occur around their (static) ambient values. Consequently, when “large-signal fluctuations” in a propagating sonic-pressure wave are transmitted into a medium having appropriate nonlinear-acoustic properties, the peak excursion of such a wave travels faster than its trough.

This nonlinear phase-wave speed dependency may be expressed in terms of some parameters labeled as A, B, etc. These have their origins in a power-series expansion of travelling-wave pressure fluctuations in terms of the so-called “condensation,” which is a dimensionless quantity given by the fluctuation of local-medium density relative to the ambient density divided by the ambient density. The A-coefficient, which multiplies the first power of the condensation, is the bulk modulus under ambient conditions and has the same dimensional units as the pressure fluctuations. The B-coefficient multiplies the second power (i.e., square) of the condensation, as well as being divided by the factorial of 2; which power-series contribution also expresses the first (usually dominant) term describing the nonlinear-acoustic effects. High-order terms further describe the nature of nonlinear-acoustic interaction.

Generally speaking, the B/A-ratio dominantly describes the nonlinear-acoustic interaction of a strong pressure wave passing into, and through, in the case of a trans-illumination interrogation configuration (or echoed back from, in the case of a back-scatter interrogation configuration) any material being sampled, thereby permitting non-intrusive identification of the material. This B/A-ratio uniquely discriminates one closely similar material from another, i.e., on the basis of their nonlinear-acoustic material properties.

By way of example, closely similar amino acids may be reliably discriminated through comparing their B/A-ratios. Likewise, Sodium Chloride (Halite, NaCl) can be separable from Potassium Chloride (Sylvite, KCl) even though both have very similar cubic-crystalline lattice material with a very similar appearance, through comparing their composite B/A-ratios. Therefore, as a non-ionizing form of non-intrusive interrogation, the present invention provides effective nonlinear-acoustic identification of the material or composition of an object.

In the case of a single sinusoidal propagating wave (i.e., a so-called “travelling mono-wave”), it becomes more and more “saw-tooth” shaped as it progresses spatially as time elapses. This degree of shape distortion is dependent upon how close the positive-to-negative peak “swings” of the pressure fluctuations—i.e., the departure from the (static) ambient pressure—approaches what is termed a pressure-source critical “shock” level. This critical “shock” level is associated with the attenuation and propagation properties of the medium (in this case air), the frequency of the wave being propagated and the lateral dimensions of the transducer projecting the sonic wave.

In fact, in air, as the progressive wave evolves towards a “saw-tooth” shaped carrier waveform, an abrupt change in pressure occurs on the front face of this propagating waveform. As such, the condition of the front face of this “saw-tooth wave starts to resemble the “shock wave front” encountered when aircraft reach Mach 1. If the air—or any other propagation fluid or material were inviscid (i.e., did not apply any viscous losses), the “saw-tooth” exhibits a “shock-wave front” that is infinitesimally thick; whereas, the amount of viscous losses govern its thickness.

In water, critical “shock” occurs in the “shock-wave front” region for pressure-induced particle velocity forward motion that is traveling at less than the speed-of-sound in water; namely, at less than Mach 1 in water. Contrary to the situation in air, the condition in water is referred to as “weak shock.” Regardless, the nonlinear-acoustic effects become more prevalent the closer the radiated pressure source level of the projected sound wave approaches to the critical “shock” level. Once the critical “shock” level is reached, saturated nonlinear-acoustic interaction is said to occur.

With regard to how harmonics created by such a strong mono-wave transmission may be harnessed, one approach is to create two such coterminous sonic waves (oscillating at separated frequencies) traveling together while nonlinearly interacting with each other. This Is called a Dual-Wave Non-Linear Sonic (DW/NLS) method. As a mono-wave, each separate equal-pressure wave creates its own set of harmonic components as the wave progresses towards a “saw-tooth” traveling waveform; which, in turn, also start to cross-interact (i.e., inter-modulate) with each other. A difference-frequency (i.e., secondary) wave is the most dominant of these inter-modulation products. It should be noted that twice the acoustic power of a mono-wave is used to bring each of these equal-pressure waveforms to within a prescribed source level relative to the critical “shock” level.

In recognition of this need for twice the acoustic power, another NLS method evolves around a mono-wave sound source using a relatively “spread-spectrum” waveform to perform inter-modulations between all pairs of spectral increments contained within such a sound-source spectrum. The result is that the spectrum of the consequential secondary waveform (or wavelet) is a modified demodulated version of the original primary waveform. Accordingly, there is a frequency downshift into a frequency range spanning from Direct Current (DC) to frequencies close to twice that of the largest bandwidth shifted frequency occurring around the carrier-frequency of the original primary waveform. This is referred to as a Self-Demodulated Non-Linear Sonic (SD/NLS) method.

A similar action can be obtained by placing non-overlapping “spread-spectrum” waveforms around each of the dual-wave carriers when using a DW/NLS method but, because of the need for twice the acoustic power, further conversion efficiency would be lost. Actually, because at least twice the transmission bandwidth also would be used, additional acoustic-absorption loses are encountered, further eroding the conversion efficiency. Consequently, a SD/NLS method is often favored over a DW/NLS method.

Another facet of NLS methods relates to whether the interaction is limited to the near field of a projection source or continues on into its far field. (The transition from near to far field, called the Rayleigh distance, is given by square of the size (e.g., for axi-symmetric projectors such as a piston, likewise, it is the area) of the acoustic-radiating projector divided by the wavelength of the primary acoustic wave. Under conditions where the primary wave frequency and projector size are such that a significant portion of the primary-wave acoustic power is absorbed in the propagation medium prior to reaching the Rayleigh transition distance, such an NLS method is said to be “near-field limited.” When the primary wave continues to significantly interact in the far field, it is said to be “far-field limited.” Furthermore, if the acoustic-pressure source level exceeds the critical “shock” level, either method would also be said to be “saturation limited” in addition to the appropriate near-field or far-field descriptor. This nomenclature applies to either the DW/NLS or the SD/NLS method. Actually, the regime just above the case when the critical “shock” level is exceeded is called the “quasi-saturated” regime because, in a region up to 10 dB above this onset, the conversion efficiency “flattens out” and, after that, takes a cataclysmic “dive.” Whereas, below “quasi-saturation” the conversion efficiency reduces by 10 dB for every 10 dB the pressure source level is below the critical “shock” level. These reductions occur relative to a baseline conversion loss which depends upon the size of the projector, the wavelength of the primary wave, the downshift ratio and a composite of the primary and secondary wave absorption per unit distance. In this way, these reductions in conversion efficiency may be gauged in terms of their actual primary-wave source level as it relates to the critical “shock” level.

Due to the acoustic absorption limitation, near-field interaction results in the secondary wave being launched from a distributed set of exponentially attenuated primary-wave radiation sources interacting to form an equivalent exponentially tapered “end-fire array” of secondary-wave sources. As such, a Rutherford beam pattern results—familiar to nuclear physicists in terms of neutron scattering—which is a narrow beam pattern possessing no side lobes; wherein, this Rutherford beam pattern broadens when “saturation limiting” occurs for a “near-field limited” case. When “far-field limiting” applies, the DW—and, for that matter, in the SD case—product of the dual beam patterns (a so-called “product” beam pattern) results and is spatially convolved with the Rutherford pattern. Generally, this Rutherford beam pattern is narrow enough to be considered a spatial Dirac-delta function so that the convolution yields a product pattern.

These beam-pattern properties are highly directional and, thereby, enable relatively small projector to be used in controlling the cross-range resolution at the primary frequency while slightly improving upon this resolution at the secondary frequency. This occurs in spite of the fact that at, say a downshift ratio of 5:1, comparable sized conventional linear-acoustic system would exhibit a 5:1 poorer cross-range resolution. This seeming paradox is not one at all because this retention of cross-range resolution comes at the expense of a conversion loss.

Another facet of near-field or far-field limiting is a change in how the secondary waveform (or wavelet) functionally arises from a pair of DWs or a single SD primary waveform. To discuss this, the real primary waveforms or waveform will be represented by its complex (analytic) signal waveform. In near-field or far-field case, the secondary waveform is respectively proportional to the second or the first time derivative of the quantity given by a complex multiplication of one signal with the complex conjugate of another or with itself. In the DW case, the analytic signal of one primary waveform is multiplied by the complex conjugate of the other primary signal waveform. Instead, in the SD case, the single analytic signal is multiplied by the complex conjugate of itself; namely, the square of the absolute value of the primary-wave analytic signal form is either doubly or singly time differentiated. When “quasi-saturation” occurs, it may be shown that the square root of this quantity is subjected to the appropriate time differentiation; whereby, in the SD case, it is the absolute value that is involved.

Another form of nonlinear interaction also is of interest. It involves inelastic as opposed to elastic nonlinear-acoustic interaction with materials and proposes to exploit the acoustic analogy of optical Raman scattering. Unlike B/A-ratio discrimination, by utilizing phonon (as opposed to photon) energy-band quantum shifting at a molecular level, this so-called acoustic Raman molecular scattering method is potentially capable of interrogating trace amounts of materials, such as biologic agents. This approach notes a Stokesian line shift to a lower frequency when intense acoustic energy is absorbed through inelastic scattering by a particular material or about 10-dB weaker anti-Stokesian line shifting to a higher frequency when acoustic energy is yielded by the material being so interrogated.

This understanding naturally leads to the question of the best primary and secondary waveforms to apply to excite elastic and inelastic nonlinear-acoustic interactions while interrogating gaseous, liquid, plasma, solid, or other such materials or combinations thereof. As previously discussed, the waveform issue also depends whether a near field or a far field interaction NLS method is deemed appropriate for the particular application is at hand. When relatively large “stand-off” distances and relatively low-frequency operation (consistent with container-wall penetration) is considered, a far-field NLS method is appropriate. Also, waveforms can be selected for revealing the presence of certain material(s) of interest.

Waveform choices can be guided by the evolution of choosing waveforms for affecting nuclear-spin excitation Nuclear Magnetic Resonance (NMR) leading to modern-day Magnetic Resonance Imagery (MRI). NMR started with “quasi-steady-state” excitation facilitated by slowly scanning the radio-wave excitation across the suspected resonance-frequency bands. Eventually, this evolved to using an ultra-wide band wavelet to “impulse” excite nuclear spin. Accordingly, a primary waveform can be uniquely designed to produce an ultra-wide band inverted Mexican hat wavelet similar to the quasi-Ricker wavelet preferred for marine seismic hydrocarbon exploration because of its match in “impulse” exciting the stratigraphic layers of the sea bottom.

Using a SD/NLS method with a Gaussian envelope—while noting that the square of a Gaussian envelope is still Gaussian shaped—modulating a primary-wave carrier, the near-field interaction produces such a wavelet by virtue of its double time differentiation inherent in this approach. However, there is a need to account for a second time derivative not provided when using a far-field interacting SD/NLS method (which is much more compatible with the requirements of the problem at hand than a near-field interacting SD/NLS method).

Accordingly, the Gauss-Rees primary waveform applies a time derivative to a Gaussian-shaped envelope to account for the time derivative missing when far-field interaction is employed. However, in order to avoid the spectral side band “splashing” caused by greater than 100% amplitude modulation (AM), a DC offset is added to this new envelope function which is used as AM for a primary-wave carrier. In addition, to avoid this carrier being radiated inefficiently by being “on” all the time, the Gauss-Rees waveform is gated by a smooth, Unitary function so as to generate a short waveform “burst” compatible with forming an equally short quasi-Ricker wavelet.

The Gauss-Rees primary waveform and its related quasi-Ricker wavelet have been demonstrated using an AR30 projector to generate a primary-wave pressure source level about 10 dB shy of the corresponding critical “shock” level. This AR30 projector used amplitude and phase equalization to offset distortion. Furthermore, transmission losses through various thickness steel and aluminum plates can also be taken into account. It also was recognized that the impedance mismatch induced as the plate is thickened may be overcome through the application of two-pass adaptation by waveform inversion then re-sending the result. An analogy can be drawn to using a pilot signal to characterize the aberrant propagation multi-path distortion and, then, correcting it on a second pass with optical phase conjugation; except that phase conjugation does not also jointly apply inverted amplitude as part of the corrective action. However, the combined action of inverting both amplitude and phase in a complex polar form is analogous to an adaptive de-convolution method that is discussed as the preferred way of describing this method for achieving vastly improved barrier penetration.

In addition, a multiple projector, synthetic-spectrum-focusing approach can forestall entering into nonlinear-acoustic interaction through focal-region waveform reconstruction. In this way, higher critical “shock” levels might be reached and, even exceeded by entering the “quasi-saturation” regime. This can involve a known way of modifying the Gauss-Rees primary waveform to accommodate operating in this “quasi-saturation” regime.

In addition, adaptive feedback can be used to control transmission and reception to remove or minimize insertion losses associated with container-wall penetration especially in the case applying an array of projectors with synthetic-spectrum focusing to improve the secondary source level as well as facilitating an enhanced “stand-off” distance capability. This application of adaptive improvement of barrier penetration is also best described in terms of adaptive de-convolution.

This SD/NLS method offers the potential for determining the properties of materials associated with their “images” inside of the containers, or really objects concealed under other circumstances, e.g., underground. The present invention provides discrimination either in small bulk amounts through a so-called B/A-ratio test or in trace amounts through an acoustic Raman molecular scattering test. Use of the acoustic Raman molecular scattering technique can facilitates “floodlighting” instead of “image-scanning” the containers so that it could be rapidly and reliably determined that no material was in any of the containers matching the signature of materials of concern. Failure of this test could trigger a slower B/A-ratio scan requiring “image scanning” that could be zeroed in on the suspected container for a follow-up detailed high-resolution assay.

At secure port of origin or destination areas, both assays could be conducted using the present invention mounted on scanning devices or at portals through which flat-bed container cargo trucks would have to drive, as well as utilizing the present invention installed on travelling loading-crane gantries. For at-sea interdiction of container-cargo vessels, the present invention can perform the interrogation from the side of, and contiguously through, any side-by-side deck mounted containers. In addition, such interrogation could be performed from above as a means to penetrate downward through layers of containers to interrogate them while reaching the below-deck cargo. A pressure-vessel-mounted variation of the present invention can be used to accomplish below-waterline interrogation via an underwater sonar mode similar to “dunking-sonar” pods employed by U.S Navy helicopters. In this way, more effective penetration of the hull plate also would result.

As yet another variant, an Unmanned Aerial Vehicle (UAV) can be deployed and wireless-telemetry controlled from a high-altitude dirigible being used with Inverse Synthetic Aperture Radar (ISAR) as a broad-ocean surveillance and Communication, Command, Control and Intelligence (CCC-I) platform. This UAV would have to be capable of carrying the present invention as a payload while loitering at a low enough airspeed to pace and slowly move around while fully interrogating a container-cargo vessel. Interrogation by an UAV with a capability to slowly maneuver above the container-cargo decks as well as off to the side would be most desirable.

Of course, the foregoing is merely a summary of the invention, intended to exemplify the robust nature of the present invention and use of the Gauss-Rees waveform in practical applications. The foregoing and other objects and/or advantages improve over the prior art as can be appreciated from the more detailed discussion of the invention that follows.

### IV. BRIEF DESCRIPTION OF THE DRAWINGS

FIG. 1 represents a conceptual Primary Wave (Gaussian) spectrum.

FIG. 2 represents a spectrum of a Secondary Wavelet.

FIG. 3 represents a temporal wavelet shape of a Ricker wavelet.

FIG. 4 represents a temporal Gaussian waveform.

FIG. 5 represents the quasi-Ricker wavelet arising after the application of a second temporal partial derivative.

FIG. 6 indicates a second derivative of the Gaussian waveform with air gun signature superimposed.

FIG. 7 represents a gated version of a carrier-borne Gauss-Rees Primary Wave.

FIG. 8 represents an energy spectrum of a Ricker wavelet.

FIG. 9 represents an energy spectrum of carrier-borne waveform.

FIG. 10 represents an energy spectrum of a quasi-Ricker wavelet with the air gun energy spectrum superimposed.

FIG. 11 represents a pre-distorted (i.e., first derivative) Gaussian Waveform plus DC offset.

FIG. 12 represents a smoothly tapered version of a trapezoidal gating function.

FIG. 13 represents the multiplicative composite of the two functions in FIGS. 11 and 12.

FIG. 14 represents time waveforms of a quasi-Ricker wavelet and a Ricker wavelet.

FIG. 15 represents an energy spectrum of a quasi-Ricker wavelet and a Ricker wavelet.

FIG. 16 represents a non-gated, transmitted Gauss-Rees Primary Waveform.

FIG. 17 represents a demodulated (secondary) source level waveform.

FIG. 18 represents a demodulated source level waveform corresponding to the temporal Secondary Wavelet as shown in FIGS. 16-17.

FIG. 19 represents a voltage spectrum of the demodulated waveform.

FIG. 20 represents a transmitted Gauss-Rees primary waveform with the duration of its Unitary gating pulse selected too short to illustrate a point.

FIG. 21 represents the demodulated source level waveform with distortion resulting from the distorted waveform illustrated in FIG. 20.

FIG. 22 represents a repeat of the temporal Secondary Wavelet as seen in FIG. 21.

FIG. 23 represents a voltage spectrum of the distorted demodulated (secondary) waveform.

FIG. 24 represents an un-gated Gauss-Rees Primary Waveform that has been scaled by 2:1 to illustrate time compression.

FIG. 25 represents the corresponding time-compressed demodulated (secondary) source level waveform.

FIG. 26 represents a voltage spectrum of the time compressed demodulated waveform.

FIG. 27 represents typical B/A parameter ratios for illustrative gases, liquids, and solids.

FIG. 28 is an illustration of a high level overview of a representative apparatus in accordance with the present invention.

FIG. 29 is an illustration of a representative of orientations for the transmitter, receiver, and object in accordance with the present invention.

FIG. 30 is an illustration of a representative receiver in accordance with the present invention.

FIG. 31 is an illustration of a representative processor in accordance with the present invention.

FIG. 32 is an illustration of a representative other embodiment of a transmitter in accordance with the present invention.

FIG. 33 is an overview for a multi-projector embodiment.

FIG. 34 is a detailed illustration of an add-on for the multi-projector embodiment.

### V. DETAILED DESCRIPTION OF THE DRAWINGS AND A REPRESENTATIVE PREFERRED EMBODIMENT

The present invention involves discovery of a new waveform I have named a Gauss-Rees waveform. This waveform can be characterized as set forth below.

### The Gauss-Rees Waveform and its Related Quasi-Ricker Wavelet

The Gauss-Rees waveform has an analytic form given by

ψ(t)=g^{1/2}(t){1−(2at)exp[(1−(2at)²)/2]}^{1/2}exp(iω₀t).

Consequently, its real part is given by

R[ψ(t)]=g^{1/2}(t){1−(2at)exp[(1−(2at)²)/2]}^{1/2} cos ω₀t;

where the constant “a” determines the time scale of the waveform by having the units of bandwidth of the envelope of a Gauss-Rees waveform in cycles/seconds=hertz, likewise ω₀=2πf₀ so that f₀ in hertz also determines the center frequency of the carrier of a Gauss-Rees waveform. It is to be noted that the direct-current (DC) offset represented by the unity value in front of the exponent within the braces is applied to just achieve but avoid greater than 100% amplitude modulation which would introduce side-band “splash” of the carrier.

A gating-pulse function, g^{1/2}(t)=U(t), of a Gauss-Rees waveform is chosen to be a “good” function—such as a Unitary function, U(t)—with continuity for every value of time, t, in all of its time derivatives, including (−∞, +∞). This gating-pulse function is included so as to prevent the otherwise continuous-wave (CW) carrier from causing inefficiency by wasting non-useful acoustic energy outside the main body of the Gauss-Rees waveform envelope. The Unitary function used as a gating pulse in the Gauss-Rees primary waveform has the form

$$\begin{matrix}U ( t ) = {\int }_{\vert t \vert}^{1} exp \{ - 1 / [ ( αξ ) ( 1 - ( αξ ) ) ] \} ⅆ ξ / \\ {\int }_{0}^{1} exp \{ - 1 / [ α ξ ) ( 1 - ( α ξ ) ) ] ⅆ ξ ;\end{matrix}$$

wherein, this Unitary function has a value of unity at t=0 and also has the property that U(αt)=U(αt−1) while also being symmetrically disposed around t=0. This Unitary function also has an extended “flat top” around zero yet exhibiting a smooth transition from the “flat-top” region into its “rise” and “fall,” respectively, disposed symmetrically on either side of t=0 and then smoothly transitioning into its negative and positive “tail” regions that respectively asymptotically merge to U(−∞)=0 and U(+∞)=0; while all of its first and higher order time derivatives also possess the same asymptotic property.

As a consequence of these properties, when the self-demodulating nonlinear interaction of the medium continues into the far field of a projector—as characterized by a single time derivative—this Unitary function does not introduce significant contributions from its time derivative. (It is to be noted that Lord Rayleigh defined the near-field to far-field transition radial range, rₜ, by rₜ=Af₀/c_{A}, where c_{A} is the “small signal” speed-of-sound in the propagation medium.) Otherwise, such time derivatives would multiply other uninteresting terms arising from derivatives of the non-gated Gauss-Rees waveform envelope. Therefore, one the way of making an adjustment to obtain the optimum duration of the Unitary function in its use as a gating pulse would be to keep on extending the duration of this gating pulse until a pre-determined small amount of quasi-Ricker wavelet distortion remains. The amount of tolerable distortion to avoid any perceptible perturbation can be gauged by making a direct comparison with the nearly ideal quasi-Ricker wavelet that occurs for extremely long duration, but inefficient, gating pulse.

The self-demodulating form of far-field nonlinear interaction that occurs below or up to the so called critical-shock region (and, therefore, is an unsaturated nonlinear interaction) leads to a wavelet function, F(t)=∂|ψ(t)|²/∂t. When saturated far-field nonlinear interaction is stimulated by driving the Sound Pressure Level (SPL) beyond the critical-shock level, the wavelet function generated becomes G(t)=∂|φ(t)|/∂t. There also is a desire to continue generating the same wavelet when a saturated nonlinear interaction condition is stimulated by the SPL sustained by its acoustic primary waveform in the far field. As the saturated nonlinear interaction region is entered, the previous unsaturated region behavior of a 10 dB increase in nonlinear conversion efficiency—namely, a 20 dB increase in secondary wave Source Level (SL)—occurs for every 10 dB increase in the SPL of the acoustic primary wave ceases. In fact, the nonlinear conversion efficiency “turns over” and “flattens out” for a further SPL range of about 10 dB above the critical-shock level until a cataclysmic decline in conversion efficiency occurs. This roughly 10 dB-region -wherein, a corresponding up to roughly 10 dB of secondary wave SL occurs—is called a “quasi-saturated region” that is reached when higher and higher SPLs are employed short of reaching the cataclysmic region of saturated nonlinear interaction.

In order to exploit this up to roughly 10-dB increase in secondary wave SL by reaching an acoustic primary wave SPL in the quasi-saturated region (just short of exceeding the cataclysmic region of saturated nonlinear interaction) requires an extremely high sound SL. A viable alternative is to extract an acoustic primary wave SL enhanced by utilizing synthetic-spectrum driven multiple-projector focusing to create an extremely high SL virtual sound source. Either way, to maintain the same wavelet form when the far-field SPL reaches beyond the critical-shock level and the quasi-saturated nonlinear interaction region is reached, F(t) must equal G(t), so that the envelope condition |φ(t)|=|ψ(t)|² must be observed. In other words, the square of the envelope of the Gauss-Rees waveform must be used in lieu of the envelope itself to produce the quasi-Ricker wavelet.

These two nonlinear operating regimes will be called “unsaturated” and “quasi-saturated” to distinguish them. However, rather than an abrupt “switch over” from one regime to the other, the transition is likely to be gradual. To account for this a method of controlling this smooth transition involves devising weighting functions of the difference between the peak acoustic pressure, p_{C0}, coinciding with the critical-shock (peak) Source Level, SL_{C}, and the peak acoustic pressure, p_{S0}, coinciding with the saturation (peak) Source Level, SL_{S}; namely p_{S0}−p_{C0}. Both of these SLs are referenced to the Sound Pressure Level (SPL) that would exist if the far-field acoustic pressure were extrapolated back to a distance 1-meter from the source on the basis of 1/r acoustic-pressure wave spherical spreading. SL is defined in terms of root-mean-squared (rms) acoustic pressure, where root-mean-squared pressure=peak pressure/√2 and, also by definition,

SL=20 log₁₀ (p_{S0}/√2)≈SL_{C}+10=20 log₁₀ {p_{C0}/√2)+10, in decibels (dB).

Therefore, a smooth transition from an unsaturated to a quasi-saturated Gauss-Rees primary wave envelope may be derived by forming a normalized weighting function ρ(p−p_{C0}−ε) applied to |ψ(t)| along with its complementary normalized weighting function [1−ρ(p−p_{C0}−ε)] applied to |ψ(t)|². This applies whenever the actual acoustic-source (peak) pressure level, p, is such that p_{S0}>p≧p_{C0}+ε, otherwise |ψ(t)| always applies when p<p_{C0}. It is also to be recognized that an error variable, ε, which may have ± values, has been introduced to account for the possibility that the transition does not exactly start at the critical-shock (peak) pressure level, p_{C0}, but, instead, is offset by either a positive or negative valued error variable ε. The desired smooth transition may be using an exponential function in the form ρ(p−p−ε)=exp [−σ(p−p−ε)].

Herein a decay constant, σ, (in inverse pressure units) has been introduced. When σ is small, the transitional (exponential) weighting function changes slowly. In fact, at σ=0 no transition occurs. Otherwise, as it gets to be larger, it determines how rapidly the Gauss-Rees primary waveform envelope transitions over from |ψ(t)| over towards |ψ(t)|² as saturation is asymptotically approached. Of course there is a constraint that |ψ(t)| is always used in the unsaturated region, p<p_{C0}+ε and only partially used in the quasi-saturated region when the acoustic source (peak) pressure level p≧p_{C0}+ε. Whereas, |ψ(t)|² is only used in the quasi-saturated region p≧p_{C0}+ε, where ε=0 is the most likely value for ε. These equations and inequalities would be embedded into the logic determining how to transition from unsaturated to quasi-saturated operation as a large Gauss-Rees acoustic primary SL exceeding the critical-shock SL becomes possible. This situation might be achieved either with a very high SL single projector or, with assurance, when the synthetic-spectrum focusing of an array of N-projectors is employed.

In this way, regardless as to whether the (peak) Gauss-Rees acoustic primary SL is less than or higher than the (peak) critical-shock SL_{C}, the same quasi-Ricker acoustic secondary wavelet is maintained. After some manipulation, this quasi-Ricker wavelet has the form

F(t)=G(t)=−U²(t)[2a exp(½)][1−(2at)²]exp[−(2a²t²)];

where a term involving ∂U²(t)/∂t as a multiplier has been neglected as insignificant. It may be seen that

M(t)=F(t)/[U(t)2a exp(½]=−[1−(2at)²]exp[−(2a²t²)]

is the form of the well-known inverted Mexican-hat mother wavelet that has a normalized form of its Fourier transform—shown by the transform operator ℑ{.}—given by

ℑ{M(f)}/ℑ{M(f_{P})}=(f/f_{P})²exp[1−(f/f_{P})²];

where the wavelet time-scaling parameter a=πf_{P}/√2 and f_{P} is the modal frequency of the normalized Fourier-transform complex amplitude spectrum—whose energy spectral density is the absolute valued squared.

This time-scaling parameter also appears in the Gauss-Rees primary waveform formulation. Therefore, a reduction in the time-scaling parameter, a, “stretches” the time scale (and, consequently, “compresses” the spectrum) of both the Gauss-Rees primary waveform and the corresponding quasi-Ricker wavelet, and vice-versa when the time-scale parameter, a, is increased. Furthermore, it should be noted that the equivalent rectangular pulse that has the energy as F(t)—i.e., the same area as F²(t)—occupies a region of time (−T_{E}/2,+T_{E}/2); where T=3π^{1/2}/16a=0.332335/a=(⅜)(2π)^{1/2}/f_{P}. The quasi-Ricker wavelet, unlike its Ricker-wavelet counterpart that is one and one-half cycles of an inverted cosine wave, has a zero mean. This means that a quasi-Ricker wavelet does not have a mean (i.e., average) value to work against the hydrostatic pressure of water—whereas the Ricker wavelet favored in land seismological exploration for hydrocarbons does—if such a wavelet were to be used in conducting marine seismic exploration for hydrocarbons. It also has the additional advantage that it also is proportional to an inverted Mexican-hat mother wavelet that may be found, for example, in a MATLAB toolbox. These advantages carry over to its use in parametric ultra-wide band sounder system applications for seeking out all sorts of objects, generally, concealed from direct observation; particularly so if a metal barrier also is involved.

So to summarize, the present invention involves discovery of a new waveform hereby named a Gauss-Rees waveform. This waveform can be used in anticipating a nonlinear action that applies another single time derivative to the absolute value squared of an analytic representation of this waveform in the process of forming an ultra-wide band inverted Mexican hat wavelet. The latter is also called a quasi-Ricker wavelet in seismic parlance. This wavelet has a form that would arise from double time differentiation of a waveform envelope that mathematically was a Gaussian function of time, wherein it also is noted that the square root of a Gaussian function of time is also a Gaussian function of time. Noticing these properties, Rees conceptualized the Gauss-Rees waveform as being structured by singly time differentiating a Gaussian function of time then offsetting its consequential negative values by an appropriate direct-current amount that brings its sum with the peak negative back to zero. The square root of the resultant, then, was applied as an envelope for amplitude modulating a sinusoidal carrier whose, otherwise, infinite time excursions were curtailed by an optimally chosen unitary gating pulse.

Further, I have invented ways so make this waveform useful in practical embodiments; for example, in identifying an object by both shape and material composition. By combining a primary waveform composed of a Gauss-Rees envelope function for amplitude modulating a continuous wave (cw) carrier, a self-demodulating/nonlinear sonic (SD/NLS) interaction can be created in a medium such as air, plasma, liquid (e.g., water), land, etc. Based upon this combination, a quasi-Ricker wavelet (having the desired properties of a standard inverted-Mexican-hat wavelet) can be created through SD/NLS interaction by operating at a frequency and with a Unitary-pulse-gating duration capable of forming an optimum number of carrier cycles inside of the Gauss-Rees envelope.

Such an interaction can be designed to create an approximately 5.1 frequency “downshift” while forming a (100% bandwidth/touching base-band/zero mean) quasi-Ricker (sometimes known as an inverted-Mexican-hat) secondary wavelet. Once stimulated in an object through nonlinear interaction by the Gauss-Rees primary waveform, the secondary wavelet is particularly useful in identifying an unknown object. This is because, when aided by adaptive de-convolution, as with the Gauss-Rees primary waveform, the secondary wavelet can penetrate even thicker walls to provide non-intrusive, remote sensing of the object. The sensing is carried out via “impulse” excitation of the backward, off-axis, or forward (i.e., trans-ensonification) scattering from constituents of certain material(s) comprising the object . . . material(s) that otherwise would be unknown, concealed, or obscured. Such material may be of a large scale, such as an explosive, or may be molecular compounds, or even on the atomic or isotope level of identification.

The present invention enables identifying an object in a variety of applications. As, for example: a) inside of the wall of a container (e.g., a cargo container or storage container or room or carrying case or luggage, etc.); b) explosives enclosed in the casings of certain land-mines buried in sandy terrain or sea-mines buried in the sea-bottom mud; c) hydrocarbon deposits buried in relatively deep strata of the earth, even under deep water areas of the Continental Shelf; d) hidden in a vehicle (e.g., an automobile or truck or speed boat or commercial or general aviation aircraft, etc.), and many other applications in which an object is in any other enclosure that is penetrable by “impulse” acoustic imaging/spectroscopy. Such applications share in common the use of the discovery as a means for revealing and identifying an unknown object, even when the object is concealed.

As discussed subsequently, detection can facilitate identifying shape as contrasted with (or in combination with) composition, thereby facilitating a discerning of a knife rather than simply discerning the composition of the knife.

Returning for a moment to further elaborate identifying composition, consider as an illustration, a narrowly directed, very low side-lobe beam formed from a small sound projector operated at the primary wave form frequency. The particular media in which such an object is concealed, immersed, buried, etc., can cause an effect through SD/NLS interaction. The effect has desirable beam-ensonification characteristics when “downshifted” to a touching base-band region of frequency in the process of forming a secondary wavelet. A receiver or an array of receivers (either ultra-wide-band microphones or hydrophones for, respectively, collecting in-air or underwater “target” responses) receive scattered signals to be amplified through a respective low-noise, sensitive ultra-wide-band “impulse” response receiver. The signals are optimized to signal-process Mexican hat or inverted Mexican hat secondary wavelets such that a spectroscopic analyzer can be used for identifying the composition of the object, whether concealed or not. Composition is identified through the appearance of spectral component(s) induced by elastic nonlinear-acoustic interaction or inelastic-acoustic scattering within the object. Accordingly, a non-intrusive way of remote sensing both the morphology and composition of the object is provided.

A parametric ultra-wide band sounder system of the present invention provides penetration of a wider range of (e.g., conducting) barrier materials than ultra wide band (UWB) radar while having at least equivalent resolving power. Indeed the parametric ultra-wide band sounder system is facile in identifying the morphology of the object through imaging, and preferably in combination with identifying object composition properties through continuous wavelet transform analysis and spectroscopic examination, respectively, of nonlinear-acoustic properties or inelastic-acoustic scattering.

The range of applications for the Gauss-Rees Primary Waveform quite broad, and not limited to these illustrative examples; wherein, the obscurity of this unique derivation is specific to SD/NLS far-field interaction. This is opposed to the case for near-field interaction (which has applications in the ultrasonic Secondary Wavelet frequency region of an even higher frequency Primary Waveform projector as constrained by the near-field absorption limiting considerations).

At this point some technical precepts of the invention seem warranted. As facets of nonlinear acoustics in various solid, liquid, gas and plasma media, the purview of this parametric ultra-wide band sounder invention is far wider than any other previous use. To convey this, instead of Sonar systems, that usually imply underwater sound equivalents of radar, such is altered to cover a much wider variety of Sonic systems. Furthermore, the word Sounder is used to embrace a far wider vista of applications associated with the unique Gauss-Rees primary waveform that provides an ultra-wide band secondary wavelet. This provides a way of exploiting a hitherto uncovered low-frequency utilization of nonlinear acoustics to not only echo-range or image but even more importantly, reveal the material composition of objects.

Support of this broad statement requires some understanding of nonlinear acoustics and how its parametric nature alters both the local existing bulk modulus, κ(p(x, t)), and density, (p(x, t) as a parametric function of the local space-time acoustic pressure-wave variations. That is, a possible three-dimensional spatial position vector, x, and a time, t, varies with the pressure wave, p(x, t), in the medium through which a nonlinear-acoustic wave travels.

As a consequence, the corresponding “large acoustic signal” nonlinear-acoustic traveling wave pressure fluctuation, p(x, t)=p(x, t)−p₀, progresses at a phase wave speed given by a space-time varying quantity c(p(x, t)=[κ(p(x, t))/(p(x, t))]^{1/2}. In these various expressions, the superscript is used to indicate the fluctuations or variations from their ambient values that are indicated by the subscript 0 placed on each of the independent and dependent variables. Then κ(p(x, t)=κ(p(x, t)+k₀, (p(x, t))+₀, p(x, t)=(x, t)+p₀ and c(p(x, t))=c(p(x, t))+c₀, for the ambient medium values of bulk modulus, κ₀=κ(p₀), and density, ₀=(p₀). As shown, the ambient medium values are each a function of the medium ambient (mean) pressure p₀ or the “small acoustic signal” ambient acoustic phase wave speed c₀=[κ₀/₀]^{1/2}.

These formulations are provided to facilitate understanding about the nature of nonlinear-acoustic traveling waves. At “large acoustic signal” levels the speed-of-sound varies during the progression of nonlinear acoustic wave. (This is opposed to the so-called “small acoustic sound” level equations used to describe conventional underwater sonar or in-air sonic wave propagation. Such equations ignore the effects of compression of the medium on the bulk modulus and density values as an acoustic wave progresses through the medium.) In fact, as a large positive pressure “swing” of a propagating wave locally increases the pressure of the medium above its ambient value, the “peak” of the wave locally travels faster than the “small-signal” speed-of-sound, cₒ. Conversely, for a large negative pressure “swing”, the corresponding wave trough locally travels below cₒ. The consequence of this is that under these conditions, the “peak” of a propagating nonlinear-acoustic wave “out-runs” its associated “trough”. In doing this, a sinusoidal (mono-frequency, fₒ) traveling wave would become “saw-toothed” in its shape; thereby, being composed of a family of harmonics (fₙ=n fₒ, n=1,2, . . . of the fundamental frequency, fₒ. of the original mono-frequency wave.

Components of this harmonic family inter-modulate with each other to form new components given by f_{m,n}=fₘ±fₙ=(m±n)fₒ. Generally speaking, the inter-modulation components associated with the + sign do not propagate very well because of the increase of acoustic-energy absorption that attends and increasing frequency of a propagating acoustic wave. This also generally holds for the non-inter-modulated harmonics having values of n greater than unity. In turn, the negative sign generally favors lower-frequency propagation through the medium. In fact, this form of inter-modulation due to nonlinear-acoustic interaction gives rise to Secondary Wave components that are “downshifted” in frequency from the original Primary Wave frequency to a frequency location “touching base band” by a process called Self-Demodulation (SD) interaction. This is as opposed to Dual Wave (DW) interaction that, due to projector “Q” limitations, usually has a secondary-waveform bandwidth less than 20% rather than the 100% bandwidth implicit in this invention. To distinguish this invention, the associated NonLinear Sonic (NLS) system utilizes a unique Gauss-Rees primary waveform, quasi-Ricker secondary wavelet form of nonlinear-acoustic interaction mechanism called a Self-Demodulated/NonLinear Sonic (SD/NLS) system. Such is opposed to much more bandwidth restrictive and at least 3-dB (calculated to be closer to 5-dB) less efficient, Dual-Wave/NonLinear Sonic (DW/NLS) systems.

Basic nonlinear-acoustic interaction phenomena such as “saturation” and the associated “critical-pressure” levels associated with the onset of underwater “weak shock” or in-air “shock” are best described and quantified in terms of mono-frequency waves. However, the mid-to-late 20^{th} century emergence of underwater NLS (or, as sometimes know, parametric sonar) from knowledge of nonlinear acoustics dating back to the 19^{th} century arose from the consideration of something called Dual-Wave (DW) interaction. Of course, replacing a mono-frequency carrier wave with a dual-frequency pair of carrier waves uses twice as much acoustic power to reach a particular level; hence the loss of 3 dB without accounting for additional losses when compared to the better waveform efficacy supported by the invented SD/NLS system.

This may be understood by recognizing that these underwater (and, for that matter, all) DW/NLS systems involve the projection of two acoustic beams that overlap each other in the form of a pair of coterminous traveling nonlinear-acoustic waves. The dual carrier waves each have any individual form of amplitude modulation and/or phase modulation centered at two respectively different frequencies, f₁ and f₂. Unlike the SD/NLS system of this invention, any modulation spectrum on each of the carriers of the DW/NLS system Primary Waves has to have a bandwidth ratio small enough that their individual (possibly different) spectra do not overlap each other. Whereas, the only constraint on the SD/NLS system Primary Wave modulation bandwidth is that it does not overlap the Secondary Wave base-band SD spectrum; which is exploited to its fullest in the invention herein described.

Returning to the mono-frequency carrier wave, the so quantified “saturation” criterion punctuates the difference between unsaturated and saturated nonlinear-acoustic wave performance for both the SD/NLS invention cited herein and the inherently narrower band, at least 3 dB or more inefficient DW/NLS systems. There is a change in conversion efficiently depending upon whether or not the peak-amplitude swing of a large-signal nonlinear-acoustic wave remains below the critical shock level. The form of shock referred to in the term critical shock level is considered to be weak shock in the underwater case or the type of shock (typically associated with shock waves) known to occur in the air. Either way, a shock front occurs within the steep trailing-edge return portion of the saw-tooth carrier waveform that is generated by the previously mentioned nonlinearly induced peak/trough dispersion of the speed-of-sound respectively in water or in air.

The conversion efficiency is defined as the power ratio (usually converted to decibels) of the Secondary Wave acoustic power to Primary Wave acoustic power; where the Primary Wave (effective) acoustic power also suffers some depletion due to power lost in creating harmonics. In the unsaturated nonlinear-acoustic interaction case, the conversion efficiency increases by 10 dB for every 10 dB increase in the Primary Wave (effective) acoustic power; thereby resulting in a 20 dB increase in the Secondary Wave acoustic power until the Primary Wave amplitude approaches the critical-shock level. However, over a region of Primary-Wave amplitude from the critical-shock lever to about 10 dB or so above it, the conversion efficiency starts to flatten-out (with a fairing-in region occurring around the critical-shock level). In doing so it remains substantially constant as the Primary Wave (effective) acoustic power continues to climb by another 10 dB. The result is a 10-dB increase in the Secondary Wave acoustic power. Beyond this region of the saturated range, a cataclysmic demise of conversion efficiency occurs because the otherwise extremely steep shock front region is eroded by viscous losses, and no further increase in Secondary Wave acoustic power results from further increasing the Primary Wave (effective) acoustic power. This is rapid depletion by viscous losses that heat the propagation medium. (In another embodiment, in the case of water, this action also causes cavitation that was shown by Soviet researches to have a beneficial action in forestalling this catastrophic demise.)

Another influence on conversion efficiency is the downshift ratio, which influences in a different fashion, depending upon whether the nonlinear-acoustic interaction is unsaturated or saturated. Regardless, a good rule-of-thumb is to keep the downshift ratio below 10:1. As a design consideration, this invention attempts to use a 5:1 or so downshift ratio. Of course, in conducting trade-off analyses for the system-design of the invention cited herein, they should be performed and checked using a high-fidelity nonlinear-acoustic interaction model, depending on the particular application desired.

In any case, consider the near-field interaction or far-field interaction of nonlinear-acoustic waves. There is a transition range at which the near-field behavior of the Primary Wave projector array gives way to a far-field behavior. This so-called Rayleigh transition range, for a square or circular two-dimensional aperture, is given by the aperture area, S, divided by the wavelength,λ₀, of the Primary Wave acoustic carrier for a SD/NLS system. For convenience, this wavelength is taken at the geometric-mean frequency when DW/NLS system twin frequencies are involved. When rectangular or elliptical apertures are involved—as they would be in different beam-widths were desired in the azimuth and the elevation directions—the Rayleigh transition range varies respectively with the eccentrically different orthogonal dimensions of this type of aperture.

Near-field interaction results from the case where absorption (plus harmonic depletion) limits the region where either SD or DW inter-modulation efficiently occurs to being in the near field of the acoustic radiating projector. Once the residual Primary Wave acoustic amplitude drops too far below the critical-shock level as a result of acoustic-absorption and harmonic-depletion losses, the conversion efficiency may have diminished below where it is significant. In that acoustic absorption causes an exponential decay of the Primary Wave traveling wave field as it progresses outwardly through the near-field region, the Rutherford neutron scattering pattern of nuclear physics arises. The Rutherford Secondary Wave acoustic beam pattern has no side lobes; and, although it broadens somewhat in the off-main-lobe direction, when harmonic-depletion losses become significant, it still does not exhibit side lobes. If an extremely short distance of coverage is acceptable, there is no major drawback of employing a near-field interacting SD/NLS or DW/NLS system. That is, except for extending the near-field distance with enormously over-sized apertures, such a condition only is realistically attainable at quite high acoustic frequencies for both the primary wave and its 10:1 or less downshifted secondary wave. Excluding the over-sized aperture as a pathologic case, range coverage will be severely limited by acoustic absorption of the Secondary Wave.

Far-field interaction is only significant when only a minor amount of acoustic-absorption and/or harmonic depletion is accomplished within the near field. Such is the case when lower Primary Wave frequencies and a downshift ratio limited to around 5:1 are employed in designing SD/NLS system Secondary Wave sources to achieve relatively long propagation ranges. In particular, interest is restricted to a SD/NLS system based upon the Gauss-Rees primary waveform invention that exhibits all of the unique and special properties described in this patent. However, the more bandwidth restrictive and less efficient DW/NLS system will henceforth be excluded as uninteresting.

Usually, sound sources at such low Primary Wave and even lower downshifted Secondary Wave frequencies—even without the benefit of adaptively improved barrier penetration—will penetrate containers and, thereby, sustain both nonlinear-acoustic interaction and inelastic scattering within enclosed materials. In this case, far-field nonlinear interaction continues even in the case of acoustic propagation spreading losses because the wave-front area over which this nonlinear interaction occurs is increasing in a like manner. However, viscous losses and harmonic depletion eventually cause “old age” over very long interactive distances and no further nonlinear conversion results to further pump and, thereby, continue to amplify the Secondary Wave.

Recalling that, beam-pattern wise, a SD/NLS system can be viewed conceptually as a subset of a DW/NLS system, the far-field interaction beam formation mechanism will be described for the DW/NLS case as a generality of the SD/NLS case. In the far-field, the pattern resulting from two overlapping DW/NLS system Primary Wave beams supporting the conterminous traveling dual waves drops-off in amplitude according to the product of the twin beams. (This product beam pattern of the DW/NLS system becomes a square-law beam pattern for the SD/NLS.) Consequently, by virtue of the conversion efficiency behavior of an unsaturated far-field interacting DW/NLS system, the Secondary Wave beam pattern also drops-off in accord with the Primary Wave product pattern. (This becomes a square-law beam pattern in the SD/NLS system case.) As a consequence of the projected near-field interaction being taken over by a dominant far-field interaction, a DW/NLS system has a composite beam pattern. It has been shown theoretically that this is given by the spatial convolution of a Rutherford beam pattern with a product (or, in the case of a SD/NLS system, a square-law) beam pattern.

Usually, the main lobe of most types of beam patterns fits reasonable closely to a Gaussian-shaped beam pattern, as also does the main lobe of a Rutherford beam pattern. Therefore, a useful approximation to the 3-dB beam-width of the composite beam pattern arising from either near-field or far-field unsaturated interaction for a DW/NLS system is given by the formula θ²={1/[1/θ₁)²+(1/θ₂)²]}+Θ_{R}²; where the composite beam-width is obtained by extracting the square-root of each side of this equation. Likewise, the same formula applies if φ₁ and φ₂ the elevation pattern beam-width respectively of the dual waves along with Φ_{R} as the Rutherford pattern beam-widths, respectively, are substituted for their θ₁, θ₂, and Θ_{R} azimuth pattern beam-width counterparts.

The composite pattern beam width of a far-field interacting SD/NLS system may be determined by invoking that the common square-law pattern 3 dB beam-width θ₀ be given by setting θ₀=θ₁=θ₂ and, likewise, φ₀=φ₁=φ₂. When the far-field interacting DW/NLS product (or the SD/NLS system square-law) beam width becomes increasingly narrower than the Rutherford pattern beam-widths the above formulations indicate that (θ, φ) tend towards the Rutherford pattern beam-widths ((Φ_{R}, Θ_{R}). This happens, conceptually, when the choice of system parameters is altered towards making either one into a near-field interacting system. In other words, in the far-field interaction limit, the spatial convolution regards the Rutherford beam pattern as delta-Dirac function; whereas, in the near-field interaction limit, it is the product or the square-law beam pattern that is so regarded.

A pair of traveling Primary Wave temporal pressure waveforms of a DW/NLS system the analytic-signal (i.e., complex) relationship for the Secondary Waveform—or, in the special case of certain applications of SD/NLS system, a temporal-wavelet—from near-field interaction may be derived by applying spatial integrals over a form:

φ_{S}(x, t|θ, φ)≈−{[D_{R}(θ, φ)βSp₁p₂]/8πρ₀c₀⁴α_{T}r}exp(−α_{S}r)×{∂²[φ₁(x, t′)φ₂*(x, t′)]/∂t′²}.

Using the asymptotic form of one of the same set of integrals from which the near-field interacting DW/NLS system case was derived, the far-field interaction counterpart is:

φ_{S}(x, t|θ, φ)˜−{[D₁(θ, φ)D₂r(θ, φ)βr₀²p₁p₂]/2ρ₀c₀³r}[┐n(π²f_{S}/α_{T}c₀)]exp(−α_{S}r)×{∂[φ₁(x, t′)φ₁*(x, t′)]/∂(x, t′)}.

Herein, the retarded-wave clock operates at a time by t′=t[1−(r/c₀)]; where c₀ is the small-signal speed-of-sound in the medium. The analytic forms of the dual space-time pressure waves are given by φ₁(X, t′) and φ₂(X, t); where * represents that a complex conjugation operation is performed. The composite acoustic absorption at each of the dual Primary Wave and Secondary Wave frequencies; wherein, in the DW/NLS system case, the latter frequency is also called the difference frequency. The quantity S is the Primary Wave projector area and the Source Level (SL) is referred to a particular value of the radial-range, r, called the reference distance r₀; wherein, r₀ usually is taken at one meter from the face of the Primary Wave projector. The peak-pressure levels associated with the SLs for the dual waves of a DW/NLS system are p₁ and p₂. In addition, the azimuth angle is θ and the elevation angle is φ; where D₁(θ,φ), D₂(θ,φ), and D_{R}(θ,φ) are the complex-amplitude beam patterns, respectively, of the twin Primary Wave (far-field interaction) beams 1 and 2 and the (near-field interaction) Rutherford beam. It also is to be noted that the natural logarithm term, arises from one of the original multiple integrals (in the spatial integral set). It acts as a weighting coefficient applied to a delta-Dirac function that is used to approximate a very narrow Rutherford beam pattern that appears in the far-field interaction beam pattern convolution integral.

Finally, β is a coefficient representing the nonlinear properties of the material in which nonlinear-acoustic occurs. In fact, in progressing along the whole propagation path, nonlinear interaction may well occur sequentially while passing through several cascaded media. For example, this also may entail nonlinear interaction occurring sequentially in passing through the main propagation medium, then through the wall of an enclosure and into the concealed material being subject to non-intrusive, remote sensing. In a seismic-exploration application, ultimately, this will entail passing through stratified layers of the Earth's crust to reach concealed hydrocarbons.

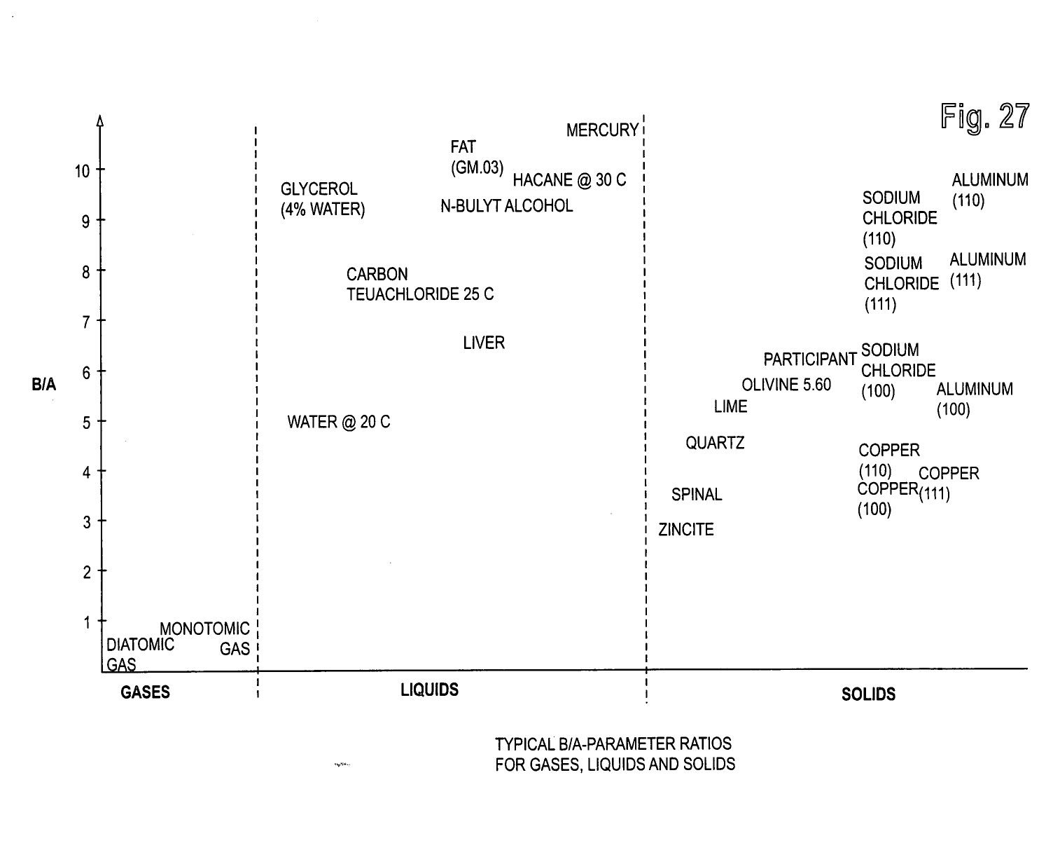

Clearly, β=1+(B/2A) is the most important factor from a materials property viewpoint. That is because A and B/2!=B/2, respectively, are also the coefficients of the s and s² terms in a power series expansion of the excess acoustic-pressure, p′=p−p₀, in terms of the condensation s=(ρ−ρ₀)/ρ₀. In addition, the A-coefficient is the p=p value of the bulk modulus (namely, the ambient bulk modulus A=κ₀) and ρ₀ is the ambient density of the material in which nonlinear interaction is taking place. It is known through comprehensive experimentation (c.f., FIG. 27) that A and B are quite unique in separating the material properties of gasses, liquids, solids and, probably, plasmas. For that matter, even the C-coefficient that appears as the C/3! coefficient of s, as well as higher order coefficients are involved in controlling the form of nonlinear-acoustic hysteresis that relates to the generation of sub-harmonic sets as well as the usual harmonic sets of spectral lines. Hysteresis arises from the additional C/3! and other higher-order terms in an expansion of the speed-of-sound in a medium, namely c(p)=c₀+c₀[1+(B/2A)][p′/(ρ₀c₀²)]+ other terms, etc.

Consequently, the C-coefficient (as the dominant higher-order coefficient) also should be given consideration in determining the nonlinear time-scale distortion of the time-delayed mother wavelet replica. Such would be employed when using the continuous wavelet transform replica-correlation integral as a means to extract the classification of a material property included in a material-signature library. Application of a maximum-likelihood data matching algorithm as a “humble” classifier—i.e., one that states that “the A, B and C-coefficients featured appear to strongly suggest the presence of an unknown material, should the material-signature library be expanded to include it?”—also warrants consideration.

In summary of the above, and as more particularly discussed below, the quasi-Ricker wavelet can be easily time (and, inversely frequency) scaled to fit range-resolution requirements. Any choice of the scaling to invariantly maintains a Primary Wave frequency and Gauss-Rees waveform downshift ratio; wherein, the preferably favored approximately 5:1 value leads to an acceptable conversion efficiency. Higher values degrade the conversion efficiency. However, when dealing with ultra-wide-band Secondary Wavelets, care should be exercised by avoiding too low a value that can cause spectral overlapping between lower-band components of the Primary Waveform and upper-band components of the Secondary Wavelet. All of these highly desirable wavelet repeatability, directionality and ultra-wide-band imaging capabilities, plus the potential for material discrimination through respectively applying continuous wavelet transform analysis to the elastic-scattering data and spectroscopic analysis to the inelastic-scattering data, as such, comprehensively come together in the present invention.

Based upon the analytic forms for near-field and far-field interaction expressed in the two formulations presented above, the complex Secondary Wavelet (when adjusted to represent that derived by SD/NLS system), respectively, is proportional to ∂₂|φ(X, t′)|²/∂t^{r2} and ∂₂|φ(X, t′)|²/∂t′. The undersigned forest noted that, if φ(X, t′) were a Primary Wave whose traveling wave form is a Gaussian envelope modulating a Continuous Wave (CW) carrier, as given by the expression exp [−(at′)²] exp (iω₀t′), then the Secondary Wave resulting from near-field interaction would be proportional to an inverted Mexican-hat wavelet, F(t′), which has the form F(t)=−(2a)²[1−(2at)²}exp[−2(at)²/2]. In other words, whenever near-field interaction applies, a Gaussian-shaped envelope modulating a CW carrier would provide a Secondary Wavelet having the desired quasi-Ricker wavelet form.

The form of the Gauss-Rees Primary Waveform (which, in toto, includes the product of a non-gated Gauss-Rees function and a gating function that achieves this) has a traveling wave form involving an envelope and carrier given by the multiplicative formulation g(t′) {1−(2at′)exp{[1−(2at′)²]/2}}^{1/2}exp(iω₀t′). There are some insignificantly weak compoenents arising from the temporal partial differentiation of the multiplicative action between the gating function g(t′), and the non-gated form of the Gauss-Rees waveform. However, the temporal partial derivative—that is brought about by far-field interaction in the medium and, consequently, is applied to the square of the modulus of this complex Gauss-Rees waveform—results in a dominant waveform component which is proportional to the combined terms F(t) [g²(t)exp(½)}/(2a)]. Wherein F(t) is the desired inverted Mexican-hat wavelet. This means that the Secondary Wavelet also has the sought-after quasi-Ricker wavelet properties.

In this formulation, g(t) is a suitable pulse-gating function—such as a Unitary function possess all of its time derivatives at every instant of time including asymptotically at ±∞—that provides the Secondary Wavelet with a limited region of “compact support” that renders the wavelet energy bounded rather than having a restored carrier that is far longer than desired. It also must not so short as to prematurely truncate the Gauss-Rees primary waveform that temporal side-lobe “ripples” become prevalent in the desired quasi-Ricker wavelet that arises as a Secondary wavelet from the action of a far-field SD/NLS system using such a pulse-gated Gauss-Rees primary waveform. It also has leading and tailing edge tapering that should be adjusted to avoid any significant edge discontinuities arising from the temporal partial derivative provided by far-field interaction in the medium.

So far the discussion has been on the use of a single sonic projector. For various reasons it is advisable to consider ways to defer the formation of a far-field interacting Gauss-Rees primary waveform, while also increasing the Sound Pressure Level (SPL) to reach and exceed the critical-shock level. It will be noted that, because a multi-projector array vastly increases the transmitter aperture area over that of a single projector, the range at which near-field/far-field Rayleigh transition occurs is way beyond that of such a single projector. In that the critical-shock level increases with the product of the medium absorption coefficient times the Rayleigh range both assessed at the center frequency of the primary waveform spectrum, the critical-shock level increases accordingly. In addition, the use of a multi-projector array provides the wherewithal to develop primary waveform source levels meeting or exceeding this increased critical-shock level.

A way was sought to achieve this while also accommodating de-convolution amplitude/phase spectral weighting—as an equivalent of a time-reversal approach that sans an inverse amplitude component, would resemble a phase-conjugation technique—applied across the whole wide-frequency band of the transmitted Gauss-Rees primary waveform. Such would need incorporation so as to achieve minimal impedance mismatch/multi-path reflection loss for improved boundary penetration purposes. An efficient way to accomplish this is to segment the wide-frequency band Gauss-Rees primary waveform into a sufficient number of narrower-band frequency regions. In this manner, much higher primary waveform source levels may be attained compatible with simultaneously and markedly decreasing the barrier-penetration losses. Combining these two approaches facilitates obtaining a large enough Gauss-Rees primary wave inside of a container to enable significantly driving the materials contained therein into their respective nonlinear regimes.

This is done so that distortion of the quasi-Ricker secondary wavelet by the local material properties may be uniquely sensed through first cross-range scanning and, then, applying correlation processing to reveal this distortion. Within each three-dimensional “image pixel” such material-property “image scanning” followed by correlation processing is achieved by suitably aligning a range-gated, nonlinear time-scaled replica of the quasi-Ricker wavelet to extract the B/A ratio of the material. This action occurs in each beam-scanned lateral horizontal and vertical dimension as well as a range-gated longitudinal dimension. In this way, each probe-volume “pixel” of this “image” may be interrogated via wavelet analysis.

Adaptive de-convolution may be applied to the back-scattered or trans-illuminated ultra-wide band, quasi-Ricker secondary wavelet once a representation of such a signal is received. As with the transmitted Gauss-Rees primary waveform—similar to seismic multi-path reflections from sub-surface stratigraphy—the form of a de-convolution filter is determined by expressing the impedance mismatch multi-path in the form of a z-plane filter. This filter is then inverted so that z-plane-zeroes in the numerator become poles in the denominator and vice versa for the poles in the original denominator. In seismic applications the improper behavior caused by singularities in this process are handled by a least-mean-square approximation or using a Wiener-filter model as a way to estimate the de-convolution kernel. However, a means similar to the treatment of a singularity appearing in a Hilbert transform seems to offer a preferred approach. Either way, the 5 KHz ultra-wide band secondary wavelet or the 25 KHz or so carrier wave centered wide-frequency band Gauss-Rees primary wave transmitted waveform de-convolution inverse filter response will be derived in a similar way; while also being applied to the overall transmitter band in the latter case.

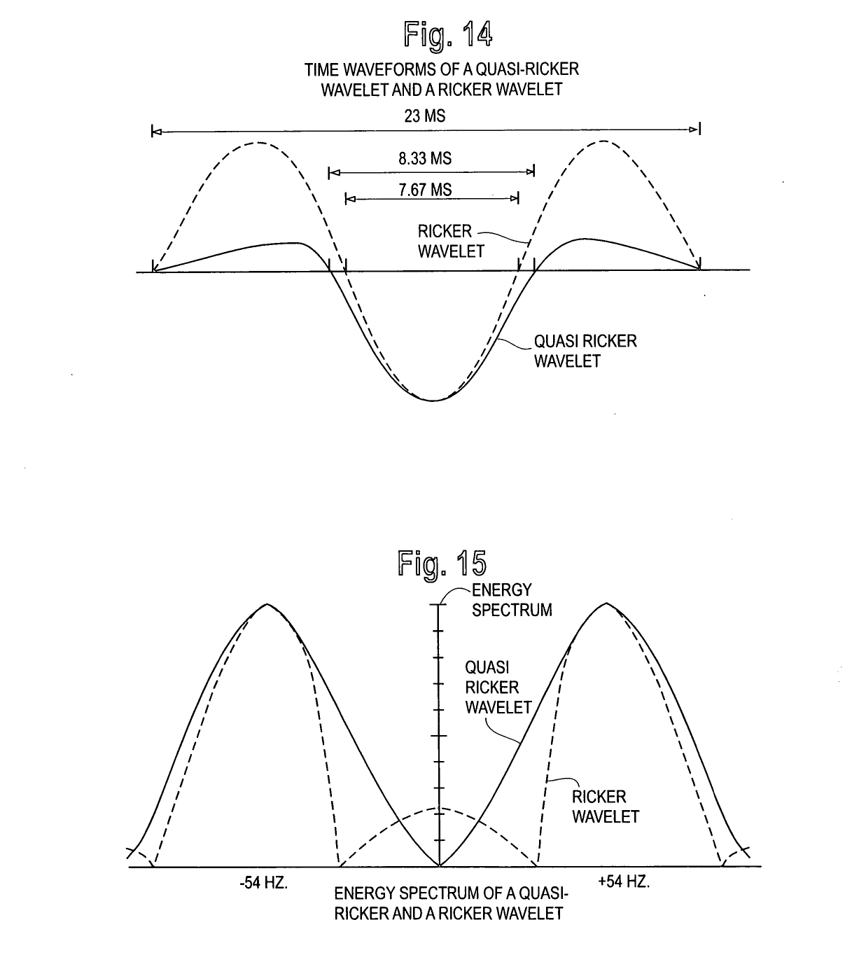

Sub-dividing the overall transmitter band into a set of relatively narrow frequency bands enables the equivalent sub-division of the Gauss-Rees waveform into the same number of frequency and phase locked pulse-stretched sub-waveforms. This technique has been named as a Synthetic-Spectrum method. Each sub-waveform may be separately transmitted through a corresponding projector in a one-dimensional or two-dimensional array of projectors populated in a relatively sparse aperiodically distributed manner (see FIG. 14); while also arranging for a non-contiguous distribution of the spectra of the sub-waveforms so as to avoid mutual interference.

After determining where the Rayleigh near-field/far-field transition of this array aperture occurs on the main response axis, time delays will be applied to bring the set of sub-waveforms into focus with each other at an appropriate focal point. This focal point will be situated at a relatively long “stand-off” distance located at about halfway within the near field of this multiple projector array. This near field will have been significantly expanded relative to that of a single projector via the much larger area of this spatially extended array aperture.

At this focal point coherent addition of the frequency and phase locked pulsed-stretched sub-waveforms leads to pulse collapsing to recover a highly amplified version of the Gauss-Rees primary waveform. This focal point will be chosen sufficiently inside of the Rayleigh region in order to keep the focal region around it appropriately compact but sufficiently far from the projector-array face to minimize near-in pressure “hot spots.” In this way, the primary-wave sonic radiation is forestalled spatially by providing a large enough “stand-off” distance for this virtual primary sound source before it becomes subjected to far-field interaction as it propagates outwardly from the focal region, respectively, passing through the air or any other material.

Consequently, the beginning of the self-demodulating, far-field nonlinear interaction region will be considerably extended out towards any container being remotely sensed. In terms of de-convolution, the amplitude/phase response of the inverse filter will be readily accommodated across the whole wide-frequency band by limiting, what otherwise would require nonlinear time-delay correction, to constant phase correction applied over each narrow-frequency band region. The constant time delays required to focus this Synthetic-Spectrum Array of Multiple Projectors will do so by applying corresponding relative time delays to each of these sub-waveform channels. In this way, both the synthetic-spectrum driven multi-projector array and the de-convolution inverse filtering for its transmitted Gauss-Rees primary waveform will be combined into this transmitter-projector module array. Wherein, an adaptive feedback loop will be applied to adjust the de-convolution parameters to minimize the barrier-penetration (i.e., impedance-mismatch/multi-path induced) losses to those due to the quite small amount of shear-wave losses and compression-wave frictional losses that are residual in a barrier comprised of metal or other material. In this context, it is important to note that Ultra-Wide-Band (UWB) radar does not penetrate metal barriers.

In this way, if desired, the primary waveform source level may be driven beyond the critical-shock level into what is called quasi-saturation. Far-field limited self-demodulation in the quasi-saturation region is governed by the first time derivative of the absolute value of the analytic form of the primary-pressure waveform. This is opposed to the absolute value squared previously shown to be applicable up to the critical-shock level. Consequently, this difference must be taken into account by modifying the Gauss-Rees waveform accordingly. It also is to be noted that, once the critical shock level has been exceeded, the conversion efficiency no longer continues to climb by 10 dB for every 10 dB of increase in the primary waveform source level. That is, in the region prior to reaching the critical-shock level, the secondary wavelet source level increases 20 dB for every 10-dB increase in primary waveform source level. Instead, once above the critical-shock level, the conversion efficiency remains constant for another 10 dB increase in primary waveform source level—namely, the secondary wavelet source level increases 10 dB for every 10-dB increase in primary waveform source level.

This action continues to occur until this constant conversion efficiency suddenly takes a cataclysmic dive after passing beyond this quasi-saturation range into a totally saturated range. There are additional complications introduced by having to modify the Gauss-Rees waveform to maintain the formation of a quasi-Ricker secondary wavelet. Of course, it is preferable in an embodiment to extract another additional 10 dB of primary-wave source level—and, consequently, another 10 dB of secondary source level—beyond that limited by the multi-projector array extended critical-shock level. However, such a system trade-off may not be considered worthwhile under the particular circumstances of an application.

A special form of wavelet analysis will be applied to scan to “match” unique material properties. This is accomplished by nonlinearly time-scale distorting a quasi-Ricker wavelet to represent the material nonlinear B/A-ratio and, even, the next higher order C/A-ratio and seeking the peak of the thus nonlinear-time-scaled wavelet replica-correlation integral to indicate the best “match” for the particular small probe-volume “pixel” being interrogated. In this way, not only will the morphology of the contents of a container be revealed but, at the same time, the unique material properties residing in each incremental probe-volume “pixel” also will be uncovered.

By exploiting the Mellin-transform wavelet equivalence, this form of wavelet signal processing also can be modified to produce constant “Q” spectroscopy for revealing the acoustic Raman molecular scattering signatures. Acoustic Raman molecular scattering should reveal the presence of trace elements (such as anthrax spores, etc.) with a sensitivity on the order of less than 1 part-in-a-trillion is made possible with non-remote sensing using mass spectrometry and ion-mobility assessment for collection and analysis purposes. Additionally, acoustic Raman molecular scattering may be employed in a “floodlight” instead of a “searchlight” mode to determine that nothing in a container “matches” any undesirable element. In utilizing the quasi-Ricker wavelet secondary wave for excitation, the proposed form of acoustic Raman molecular scattering signal processing is somewhat similar to a nuclear-magnetic resonance (NMR) analysis technique employing “impulse” excitation as opposed to “slowly scanned CW” excitation.

Turn now to the figures that illustrate some of the embodiments of the present invention.

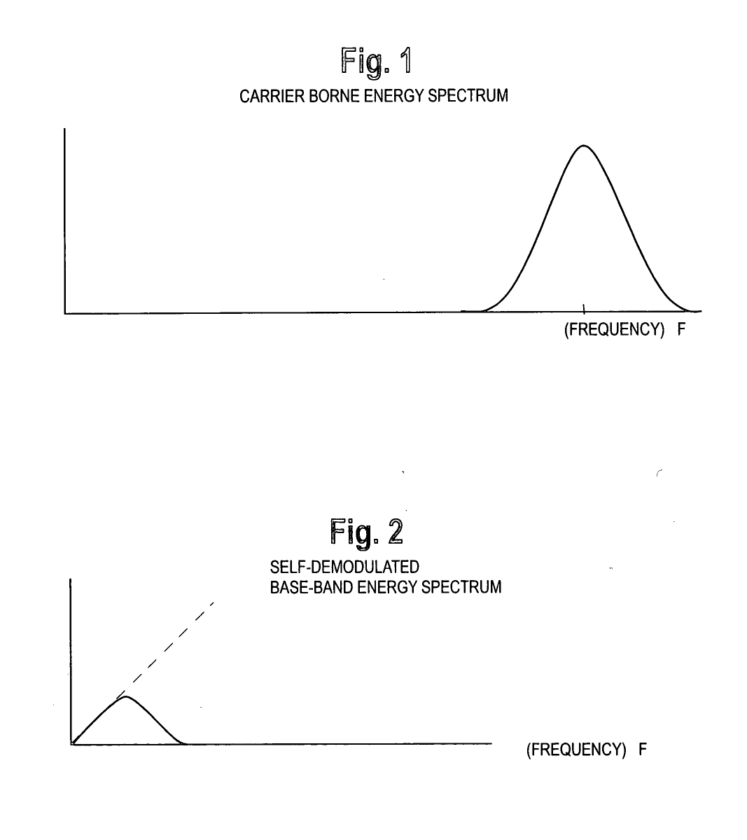

FIG. 1 represents a conceptual Primary Wave (Gaussian) spectrum. This carrier borne energy spectrum, shown in FIG. 1 with frequency, is used for a near-field SD/NLS system to produce the FIG. 2 spectrum of a Secondary Wavelet.

FIG. 2 is the spectrum of the Secondary Wavelet has a self-demodulated base-band energy spectrum. Further, the spectrum of a Secondary Wavelet in FIG. 2 has the corresponding temporal form of a quasi-Ricker wavelet or, synonymously, that of an inverted Mexican-hat mother wavelet. Generally such a near-field interacting SD/NLS system is limited to quite high frequency, short range operation. As such, it has a very limited range of utility.

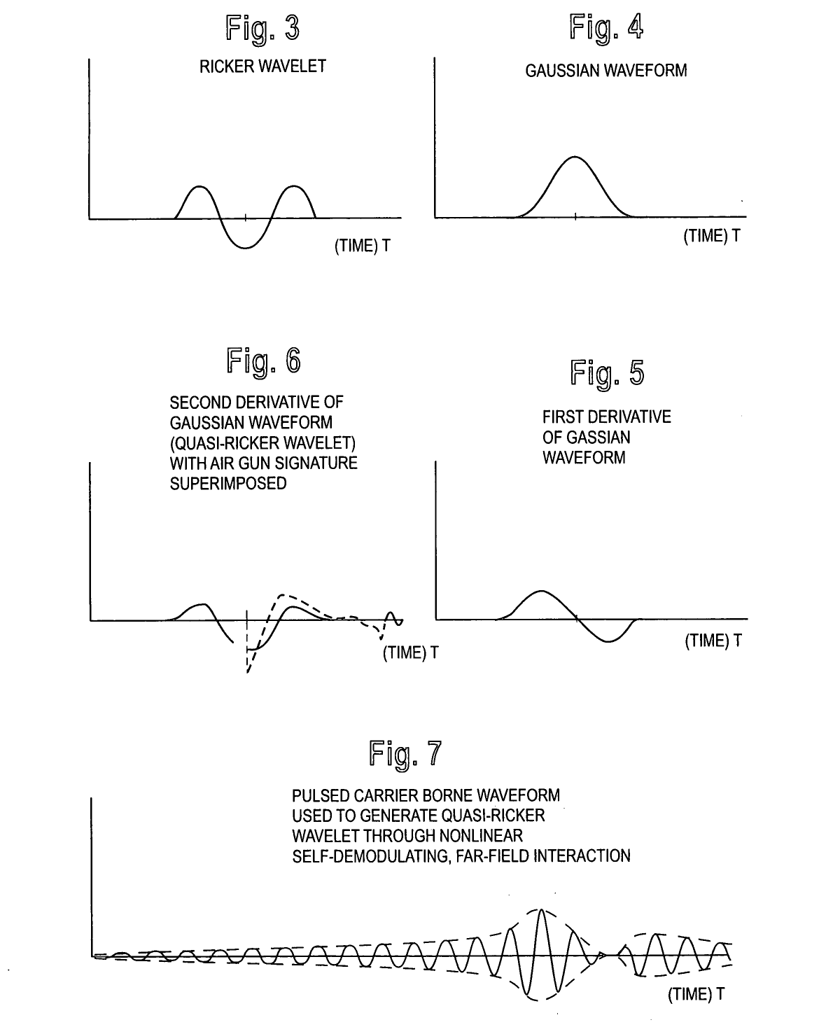

FIG. 3 illustrates the temporal wavelet shape of a Ricker wavelet, corresponding to a plus and minus three-quarters of a cycle of an inverted cosine wave.

FIG. 4 represents a temporal Gaussian waveform envelope of the near-field interacting SD/NLS system.

FIG. 5 represents a quasi-Ricker wavelet arising after the application of a second temporal partial derivative is applied. FIG. 6 indicates a second derivative of the Gaussian waveform (quasi-Ricker wavelet) with air gun signature superimposed. This intermediate wavelet shape exists after the application of a single temporal partial differentiation of the Gaussian envelope.

The temporal average of the Ricker wavelet shown in FIG. 3 is not zero; whereas, as used to avoid violating hydrostatic-pressure properties, the quasi-Ricker wavelet shown in FIG. 6 does have a zero temporal average.

FIG. 6 is the temporal smoothness of a quasi-Ricker wavelet is contrasted with a typical air-gun signature represented in dashed lines in FIG. 6.

FIG. 7 represents a gated version of a carrier-borne Guass-Rees Primary Wave used in the production of the quasi-Ricker wavelet shown in FIG. 6 when one of the two temporal partial derivatives is not present when a far-field interacting SD/NLS system is used.

A bipolar carrier being modulated by the Gaussian envelope shown in FIG. 4 may be contrasted with the FIG. 6 carrier-borne Gaussian Primary Wave used when a far-field, rather than a near-field, interacting SD/NLS system is utilized.

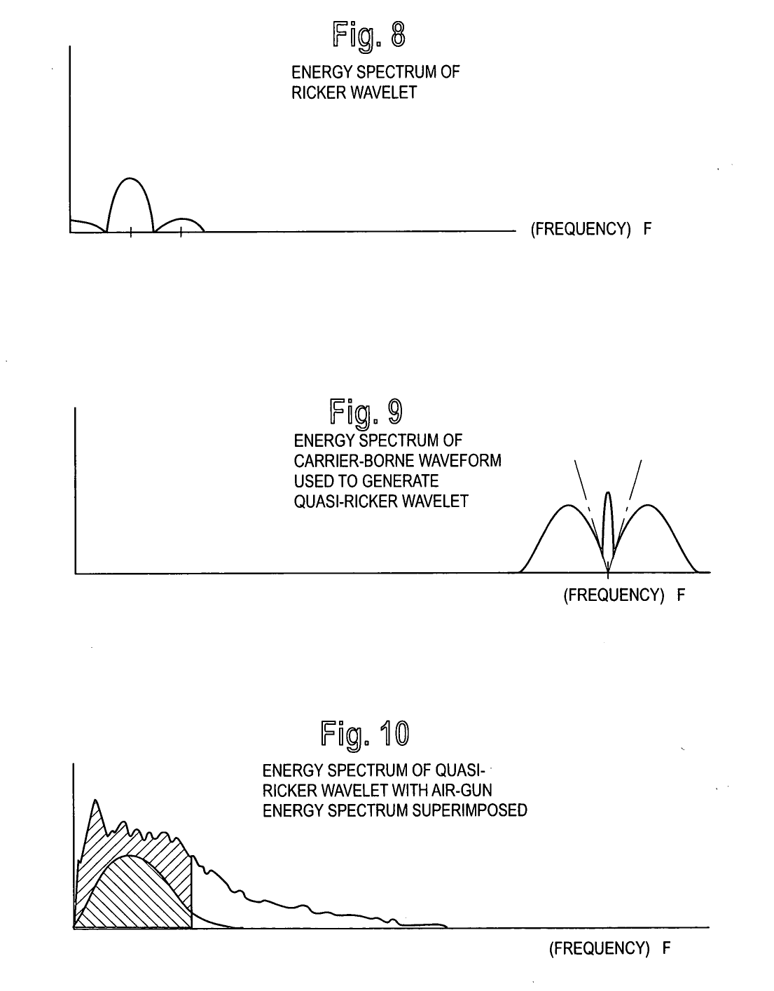

FIG. 8 represents an energy spectrum of a Ricker wavelet, more particularly illustrating a touching base-band (one-sided). In FIG. 8, the spectral side lobes should be noted along with the presence of a DC component indicating a non-zero temporal average.

FIG. 9 represents an energy spectrum of carrier-borne waveform used to generate a quasi-Ricker wavelet. More particularly, FIG. 9 represents the (one-sided) energy spectrum of the Gauss-Rees waveform used for the formation of a quasi-Ricker wavelet through a far-field interacting SD/NLS system. Note in passing that FIG. 9 also represents how super modulation is avoided though the restoration of a fated CW carrier. Had a controlled impulse generation (CIG) technique been applied, the need for this offset envelope component and the consequential gating would not be revealed and no clue would be provided to proceed. CIG was primarily devised with conventional (linear not nonlinear) sonar waveform correction in mind rather than the far-field interacting SD/NLS system approach. Without the DC offset of the modulating envelope shown in FIG. 7, super modulation would have destroyed the integrity of the Gauss-Rees waveform and the additional need for gating the CW carrier component of the present invention would not have become apparent. This is because, in this case, the envelope modulation would crossover, respectively, into both opposite negative and positive directions. Such super modulation would produce spurious carrier bursts filling the desired trough region. The Gauss-Rees Primary Waveform corrects for this type of super modulation, which otherwise causes untenable side-band “splash” and resulting unacceptable quasi-Ricker wavelet distortion in any far-field interacting SD/NLS system.

FIG. 10 represents an energy spectrum of a quasi-Ricker wavelet with the air gun energy spectrum superimposed with the dashed lines. FIG. 10 also represents the smooth (one-sided) spectrum of a quasi-Ricker wavelet. The wavelet spectrum and its corresponding temporal wavelet are highly repeatable, while an air-gun marine seismic energy source spectrum has undesirable ripples due to a secondary bubble pulse. This is shown for contrast with the quasi-Ricker wavelet energy spectrum both shown in FIG. 10. Although not shown, a multi-tip sparker marine seismic energy source would exhibit an even more ragged energy spectrum. If the desire is to produce clean seismic, multi-channel data stacking or to employ spectroscopic analysis for discerning material-specific additional spectral components (that are induced by nonlinear interaction within or inelastic scattering form concealed material), a clean Secondary Wavelet energy spectrum is important.

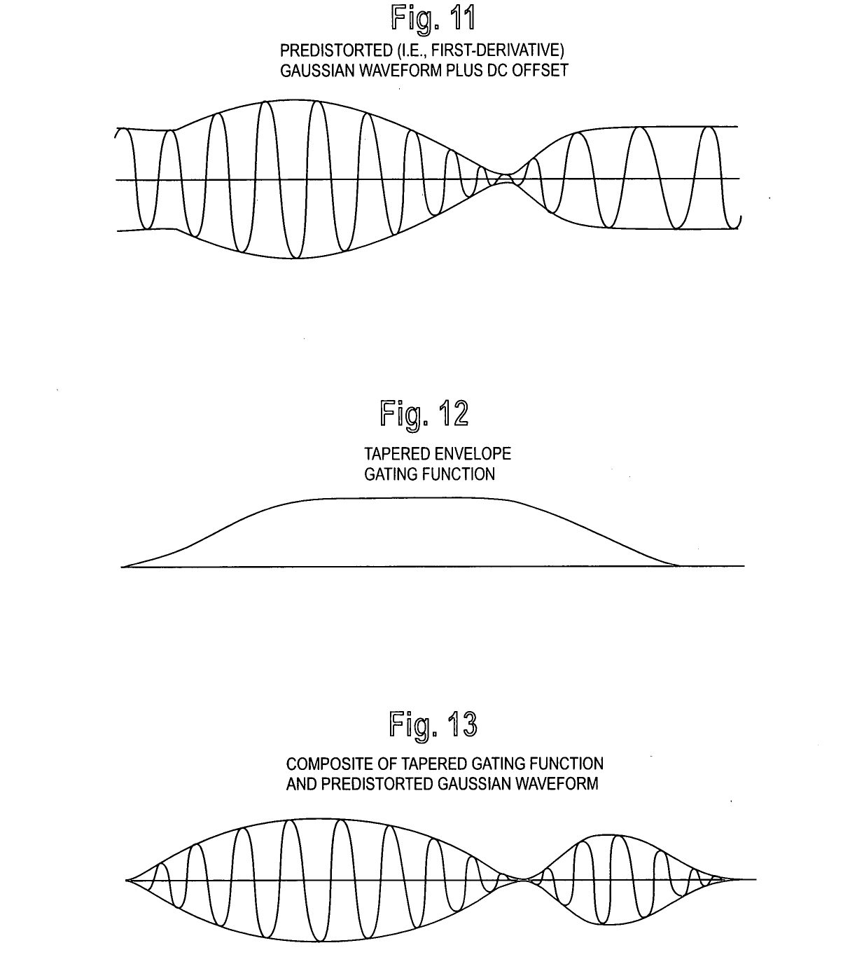

FIG. 11 represents a pre-distorted (i.e., first derivative) Gaussian Waveform plus DC offset, i.e., an un-gated Gauss-Rees Primary Waveform. A smoothly tapered version of a trapezoidal gating function is shown in FIG. 12. The multiplicative composite of the two functions in FIGS. 11 and 12 is shown in FIG. 13. In this way, FIG. 13 also is used to demonstrate that, without gating, there would be no discernible region of compact support to ensure bounded energy in the quasi-Ricker wavelet formed through far-field interacting SD/NLS system. Without gating, Primary Wave energy would be wasted in regions outside of the intended Secondary Wavelet region of compact support. The role of the DC offset should be noted in FIG. 13.

FIG. 14 represents time waveforms of a quasi-Ricker wavelet and a Richer wavelet. FIG. 15 represents an energy spectrum of a quasi-Ricker wavelet and a Richer wavelet. FIGS. 14 and 15 are used to illustrate a seismic energy-source case. FIG. 14 represents the comparative temporally quantified Ricker and quasi-Ricker waveforms (respectively shown in dashed lines and in solid lines). A wavelet region of compact support 23 milli-seconds in duration is shown. The pair of zero crossings for the Ricker wavelet are closer together (i.e., 7.67 milli-seconds) than those for the quasi-Ricker wavelet set at 8.33 milli-seconds. The consequences of this become clear from the (two-sided) energy spectral density characteristics shown in FIG. 15. These wavelets are both designed to have an energy spectral density that peaks at 54 Hz that is favored for deep seismic penetration of the Earth” hidden strata. Again, it is to be noted that the Ricker wavelet has a DC component—which is unsuitable for being sustained by the hydrostatic pressure encountered in marine seismic exploration—whereas, the quasi-Ricker wavelet has no DC component because it has a zero temporal average.

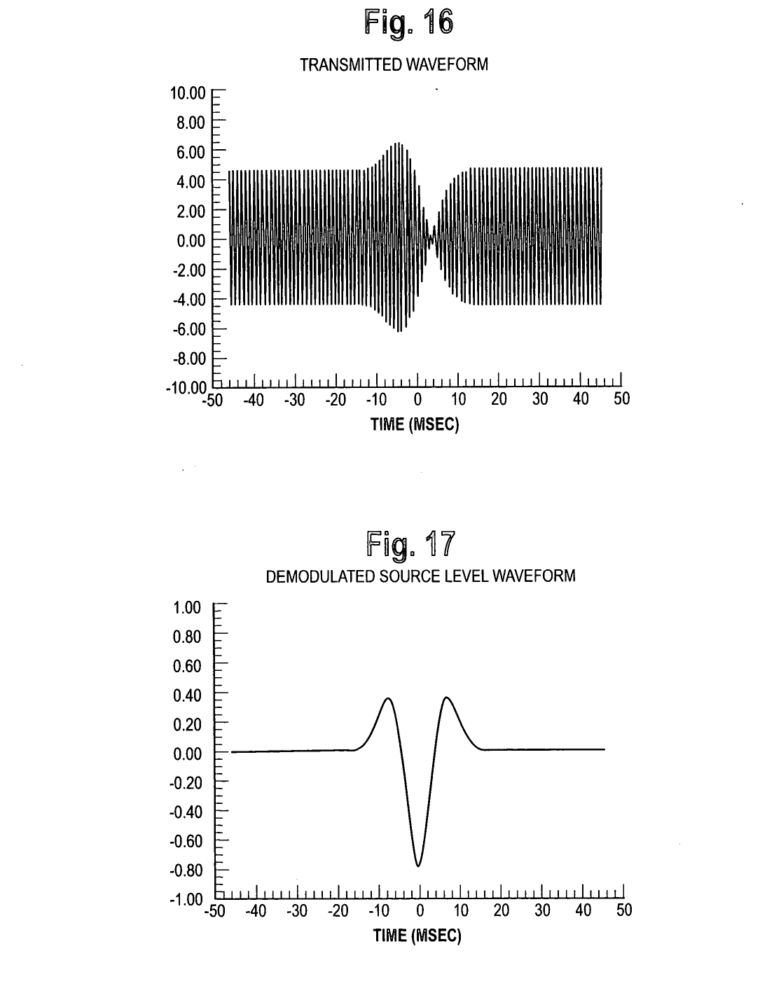

FIG. 16 represents a non-gated, transmitted Gauss-Rees Primary Waveform, for comparison with FIG. 17, which represents a demodulated source level waveform, i.e., the Secondary Wavelet formed by far-field interacting SD/NLS system. The conversion efficiency indicated is about—17.5 dB; which is about 6 dB more efficient than would be generated by an equivalent far-field interacting DW/NLS system otherwise using the same nonlinear parameters. Note that with non-linear/parametric sonar: (a) non-linear propagation characteristics of a medium cause high frequency, a high source level waveform to demodulate itself to a low frequency waveform; and (b) a demodulated waveform is proportional to the first derivative of the transmitted waveform envelop.

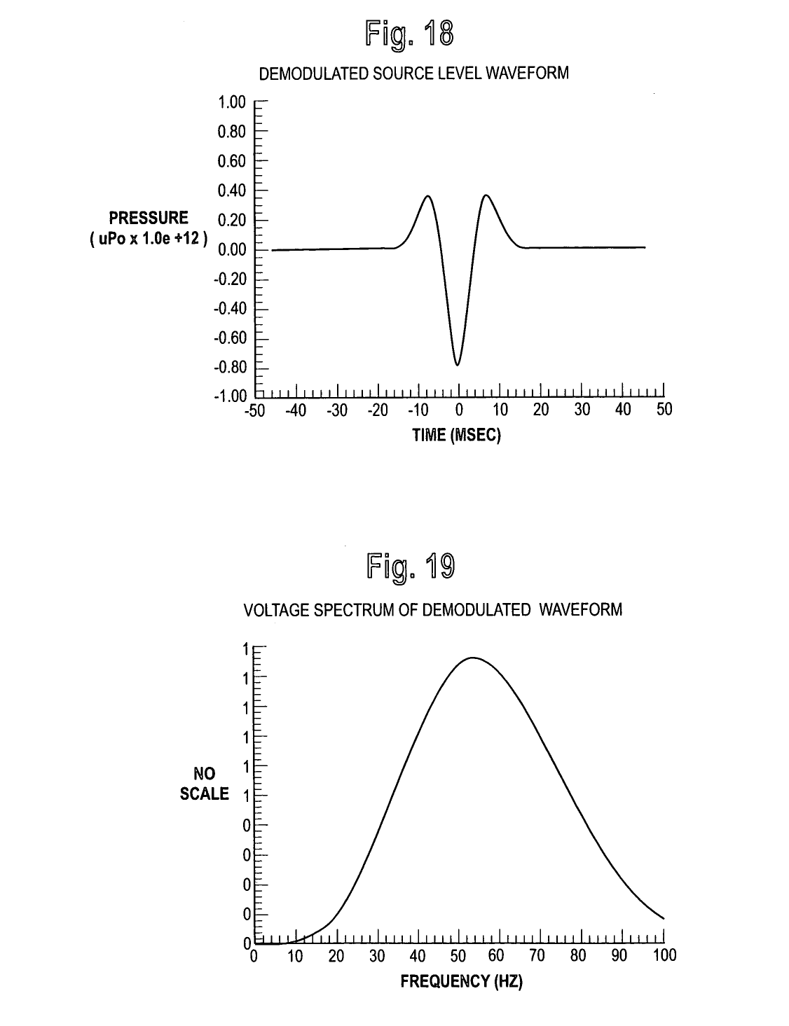

FIG. 18 represents a demodulated source level waveform corresponding to the temporal Secondary Wavelet as shown in FIGS. 16-17. This quasi-Ricker wavelet was simulated to arise from a non-gated Gauss-Rees Primary Waveform. FIG. 19 represents a voltage spectrum of the demodulated waveform, showing simulated (one-sided) energy spectrum of this quasi-Ricker wavelet. The a-parameter in the equation appropriate for this far-field interacting SD/NLS system generated quasi-Ricker Secondary Wavelet was set consistent with the previously discussed 54 Hz marine-seismic energy source.

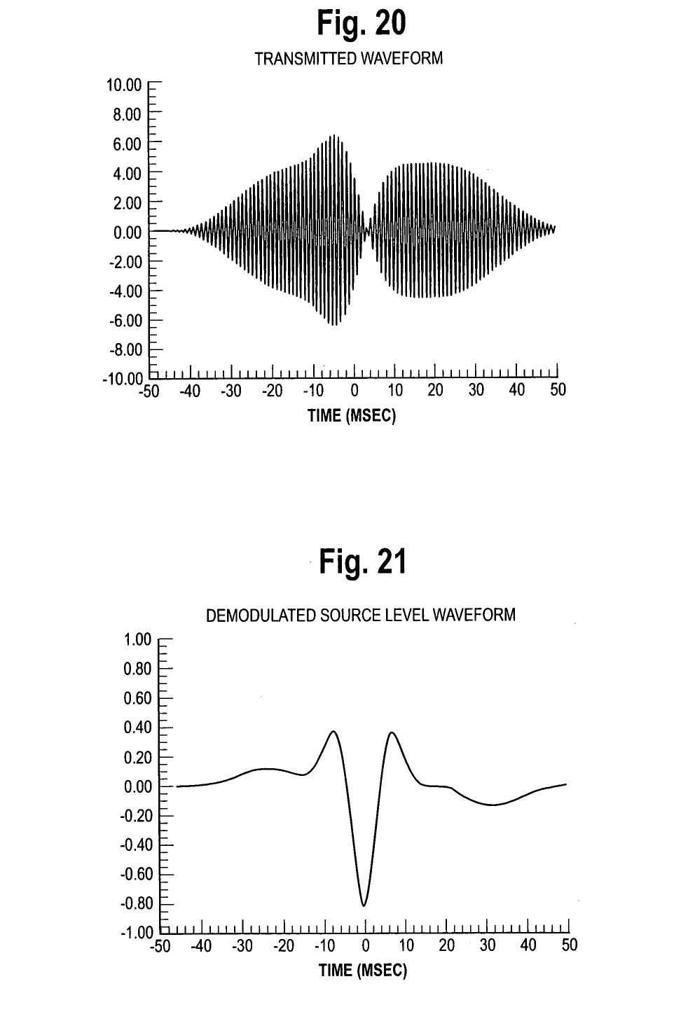

FIG. 20 a transmitted parametric sonar waveform.

FIG. 21 a demodulated source level waveform. FIGS. 20-21 are comparable to FIGS. 16-17 except a first attempt at a smoothed trapezoidal gating pulse has been illustrated through stimulation. As may be gleaned from the temporal Primary Waveform/Secondary Wavelet comparison in FIGS. 20-21, the gating pulse has too short a flat top and too rapid a rise and fall time to avoid pre- and post-Secondary Wavelet ripples, even though this design would be highly energy efficient.

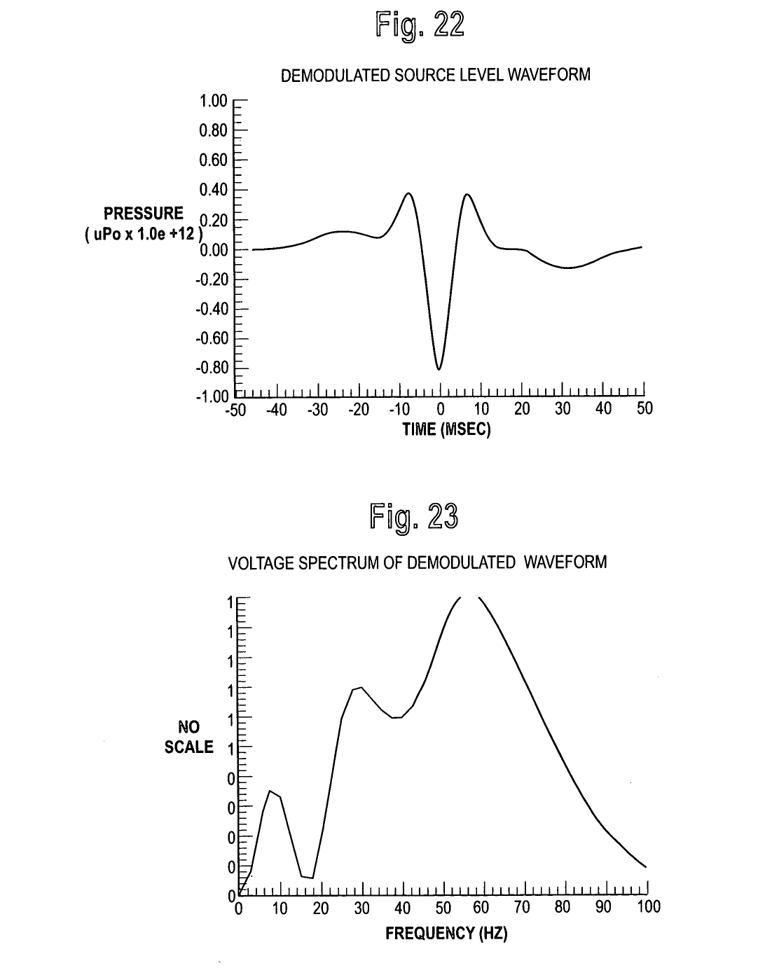

FIG. 22 repeats the (same, somewhat distorted) temporal Secondary Wavelet as seen in the FIGS. 20-21 comparison. This is done to show in FIG. 23 (demodulated source level waveform) the impact of the temporal Secondary Wavelet distortion on the corresponding (one-sided) energy spectrum. Clearly the spectral ripples associated with this first-cut design of a gating pulse would impair any detailed spectroscopic analysis. A design refinement could be constrained to reduce these spectral ripples below a level acceptable to spectroscopic analysis.

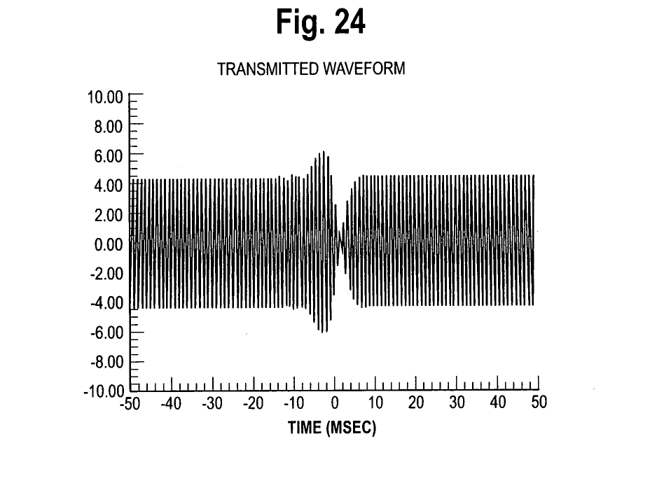

Attention is turned to scaling the Secondary Wavelet and its energy spectrum via altering the a-parameter. FIG. 24 represents a Gauss-Rees Primary Waveform that has been scaled by 2:1 relative to its longer duration counterpart hitherto used for Primary Waveform to Secondary Wavelet demonstration purposes. In order to do this, the a-parameter is increased by 2:1.

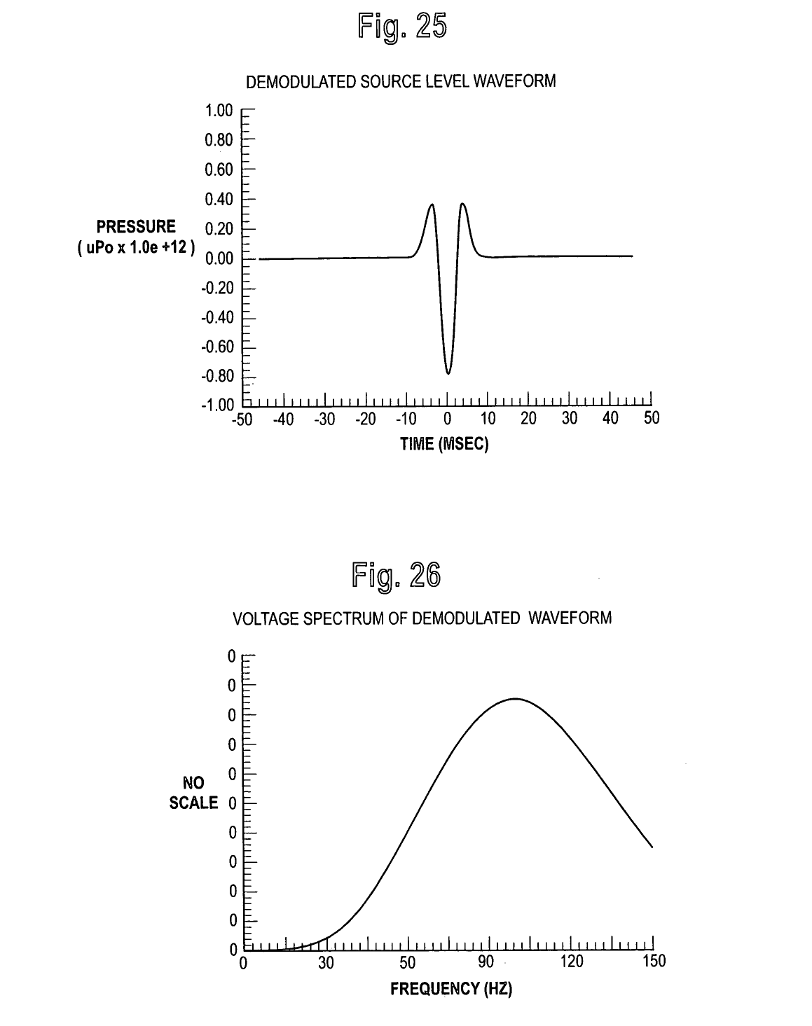

FIG. 25 represents a demodulated source level waveform, and FIG. 26 represents a voltage spectrum of the demodulated waveform. More particularly, FIG. 25 represents a corresponding Secondary Wavelet generated by the Gauss-Rees Primary Waveform shown in FIG. 24. It will be noted that, as anticipated, the resultant quasi-Ricker wavelet is shorter by a factor of 2:1. FIG. 26 represents that the corresponding (one-sided) energy spectrum stretches by 2:1 and its peak moves up from the previous 54 Hz to 108 Hz.

The foregoing discussion of the Primary Waveform/Secondary Wavelet characteristics and properties of the Gauss-Rees waveform and the quasi-Ricker wavelet generated by a far-field interacting SD/NLS system is now detailed for practice. The emphasis of the foregoing simulations has been to highlight efficiency as it relates to penetration and resolution as it applies to imaging. However, the prospects for obtaining material properties via spectroscopic analysis of the impact of nonlinear material properties and hysteresis, as well as inelastic scattering raises the question about how unique are the B/A parameter ration signatures for various gases, liquids and solids. FIG. 27 attempts to address this issue by representing typical B/A parameter ratios for illustrative gases, liquids, and solids, and thus the potential for separating and identifying various concealed materials on the basis of their nonlinear-acoustic B/A-parameter ratios.

The B/A-parameter ratio information is analyzed through the application of a wavelet replica-correlation processor; which also has its equivalent in a spectroscopic analyzer. Full separation of classes can be done on the basis of assembling a large classification confusion matrix. As a practical alternative, the present invention can monitor for, and carry out identifying of, the presence of a material having one of these signatures. In this way, the test would essentially state that there is a very high likelihood that the illicit material or materials of concern is not present even though what is present is not identified. Any indication to the contrary would initiate a finer-grain search for illicit objects or materials.

Another nonlinear-acoustic interaction that also could be utilized in a similar way involves the exploitation of acoustic Raman molecular scattering which is analogous to optical Raman scattering. In the context of non-intrusive remote sensing, nonlinear-acoustic impulse interrogation similar to that performed by Nuclear Magnetic Resonance (MRI) spectroscopic imaging is performed.

As with optical Raman (i.e., inelastic) scattering, acoustic Raman molecular scattering is expected to create frequency (downshifted) Stokesian lines at frequencies not present in the original interrogation signal spectrum. This is due o energy being absorbed into an energy-state change caused by inelastic scattering. Likewise, (frequency up-shifted) anti-Stokesian lines also would appear. This is due to energy being given-up by an energy-state change caused by inelastic scattering collisions exciting the molecules in the material. These lines would appear around the non-frequency-shifted Rayleigh or Mie elastic scattering from molecules in the material under interrogation.

Optical Raman scattering produces Stokesian and anti-Stokesian lines that typically are of the order of, respectively, 30 dB to 40 dB below Rayleigh or Mie scattered contributions. Analogously, acoustical Raman molecular scattering might be considered as having similar comparative levels for its Stokesian and anti-Stokesian lines or, through suitable extensions of previous no too oblique experimentation, might reveal somewhat different, perhaps even stronger lines. Again through analogy with optical Raman scattering, such acoustical emissions from inelastic phonon collisions are likely to be subjected to isotropic scattering.

Therefore, these Raman scattered phonon emissions might be expected to be weak relative to the elastically scattered contributions from the far-field interacting SD/NLS system; wherein, these stronger components are utilized for B/A-parameter ratio statistical testing. Even so, because the Stokesian and anti-Stokesian lines have sharp resonant peaks they should be quite discernible from the smooth quasi-Ricker Secondary Wavelet spectrum when subjected to narrow-band spectroscopy. Likewise, the signal-processing gain provided by spectroscopic analysis will effectively sizably increase the Signal-to-Noise Ratio (SNR) of the Stokesian and anti-Stokesian lines relative to the broadband noise associated with thermal agitation of the molecules within the material being interrogated.

Consequently, the present invention offers non-intrusive, remote sensing by virtue of providing better enclosure-wall penetration while maintaining equivalent range and cross-range resolution for imaging purposes. In addition, the present invention can provide identification of an object that is concealed, its shape by imaging, and its material properties through nonlinear-acoustic interaction and hysteresis, as well as through acoustic Raman molecular scattering from within the concealed material.

Turn now to FIG. 28, which provides an illustration of a high level overview of a representative apparatus in accordance with the present invention. There is a transmitter 2, which provides a waveform 10, which interacts with a medium 7 through which it is passed through container 5 to an object 4. Waveform 14, as received by receiver 6, depending upon how they are configured, results from scattered, back-scattered, forward scatter acoustic energy. Processor 8 communicates with transmitter 2 by signals over link 16, and processor 8 communicates with receiver 6 by signals over link 16. More particularly, FIG. 28 illustrates transmitter 2 that includes a Gauss-Rees waveform modulator that is discussed in greater detail below. Generally, however, the Gauss-Rees waveform modulator, depending upon whether the object is concealed from the transmitter 2 by a barrier such as a container wall 5, also may embrace a system for equalizing the multi-path reflections due to impedance mismatches at the front and back face of the barrier. Such impedance mismatches can otherwise produce a significant loss of waveform strength in passing through the wall 5. Additionally, transmitter 2 can have a digital switching power amplifier impedance matched into a single projector. This acts as a transducer means to efficiently convert an electrical waveform into a like acoustic pressure Gauss-Rees waveform, which may be distorted by feedback controlled equalization and, thereby, improve barrier penetration after the waveform encounters a propagation medium.

The changed line 12 is to illustrate that there will be differences between handling elastic and inelastic scattering. Elastic collisions have no exchange of phonon energy; whereas inelastic collisions have downward frequency shifts due to energy absorption and upward frequency shifts due to radiated energy. Respectively, elastic scattering causes Mie acoustic scattering while acoustic Raman molecular scattering is a form of inelastic scattering from the composition of the propagation medium 5, more so later, upon encountering with the object 4.

The object 4 may or may not be concealed by a barrier such as a container wall 5. If there is a container wall 5, then amelioration by the aforementioned equalization that would reside in transmitter 2. Regardless of whether the object 4 also is concealed by a container barrier wall 5, the object 4 causes both elastic and inelastic scattering as part of the nonlinear effect. The case of the elastic scattering is dependent upon the system resolution volume bulk properties (namely, first-order and higher-order nonlinear coefficients each divided by the bulk modulus) of the object. The case of the inelastic scattering is dependent upon its trace acoustic Raman molecular scattering properties.

Both the residual acoustic primary waveform 10 and the object-distorted acoustic secondary wavelet 14 are scattered by the object 4, carrying with it the incremental bulk and acoustic Raman molecular scattering signatures of the object 4 with them.

These are received at a receiver 6 through a back-scattered path, an oblique-scattered path, a forward-scattered path. Preferably by using a plurality of receivers (discussed below as another embodiment, but generally with each receiver similar to receiver 6), tomographic imaging of the object's three-dimensional shape also may be reconstructed in addition to the discrimination of the material properties of an object 4.

The receiver 6 can include an ultra-wide band microphone such as a commercially available Earthworks Microphone Model # s/n 9837A that is capable of acting as a transducer to convert both the residual carrier-borne Gauss-Rees acoustic primary waveform and the ultra-wide band acoustic secondary wavelet into their electrical counterparts.

Receiver 6 can also include a device for amplifying the strength in the low-noise with a pre-amplifier usually integrated into such a commercially available microphone. If a barrier wall 5 is concealing the object 4, then the receiver 6 can have an adaptive equalizer to ameliorate the one-pass of the acoustic secondary wavelet. Likewise, when the residual acoustic primary waveform has to make a second pass through the same barrier in returning as wave 14 to the receiver 6, it also has to be mitigated through adaptive equalization. That is, the effect of wall 5 should be taken into account in the transmitter 2 equalization process; in addition, receiver 6 can have automatic, manual, pre-programmed and time-varied gain control, pre-whitened filtering and noise normalization included as receiver 6 signal pre-conditioning functions.

Link 18 connects receiver 6 to send its pre-conditioned signals to the processor 8 in a digital format; while also sending various gain-control indicators back over the same Link 18, as discussed in more detail below.

The processor 8 is responsible for applying range gating the radial-range dimension and synchronizing the “searchlight” scan of the cross-range dimension for object-imaging purposes (which is a function not particularly needed in the “floodlight” non-scanned acoustic Raman molecular inelastic-scattering case).

Processor 8 also performs continuous wavelet transform (CWT) signal processing using a standardized wavelet derived from a region characteristic of the propagation medium as per claims 3, 4, 5 and 6 as a mother wavelet that is purposely distorted to represent the impact of the properties of various material B/A, C/A, . . . , properties stored in an incremental bulk material-properties library. Processor 8 also performs a close relative of CWT signal processing called a Mellin Transform in order to extract acoustic Raman Molecular scattering signatures for comparison with a trace-element library; wherein, decision logic is also incorporated into Box 8 to affect the object present and object not present decisions.

Link 16 is a two-way provided between the processor 8 and the transmitter 2 to facilitate synchronization and control indicators to time register the unitary-pulse gating as part of the Gauss-Rees electrical primary waveform modulator action of transmitter 2 with the radial-range gating of processor 8. Along with the synchronization of the cross-range scanning used for both elastic and inelastic scattering when the decision logic is seeking an object present as opposed to non-scanning when seeking an object not present.

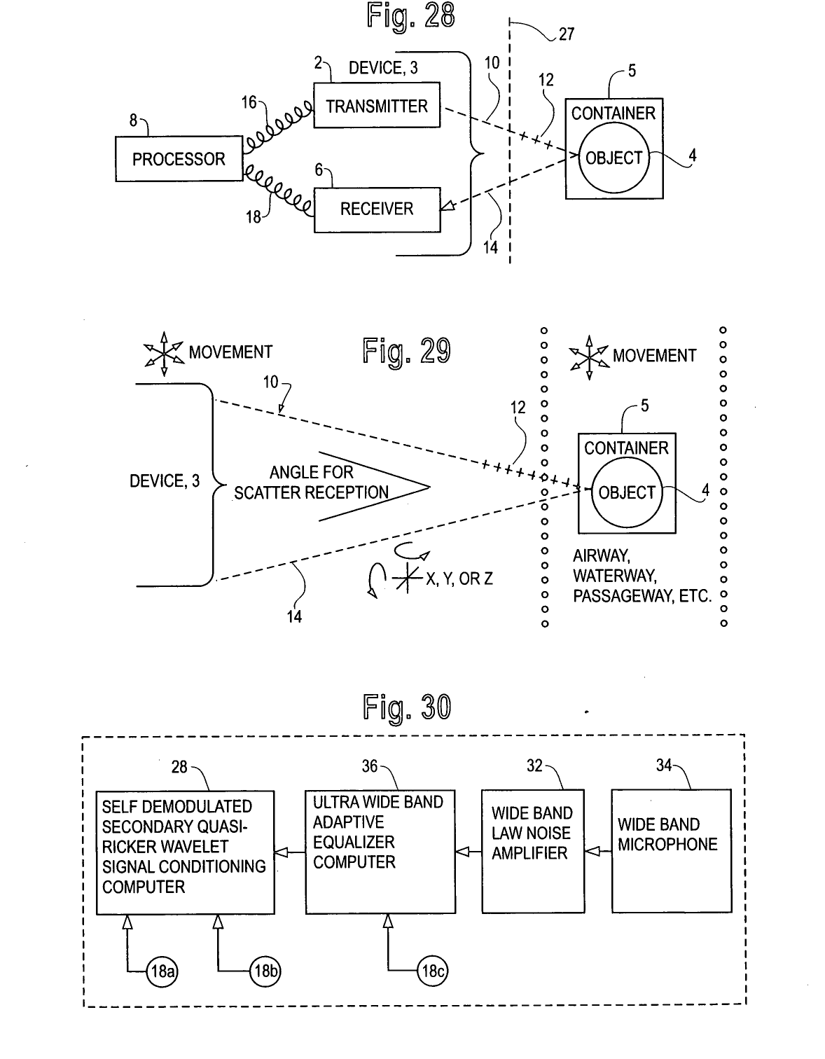

FIG. 29 provides some representative orientations for the transmitter 2, receiver 6 and object 4. The transmitter 2 and receiver 6 can be located in a device for holding both, or can be in a device for holding one or the other, as may be preferred under the particular circumstances of a given application. The device can really be any piece of equipment or a mechanism designed to serve this purpose or function. The orientation can be substantially vertical or horizontal, or from devices in such diverse applications as buoys used to defend a harbor from importing a dangerous or illegal object 4, a toll booth to monitor highways for the same, or passage ways for pedestrians, rail yards, and even battlefields. Similarly, the device can be mounted in a hovercraft, miniaturized into a hand held device, say for airport security, mounted in an airplane, drone, or robot, etc. Note in FIG. 29 various orientations shown by alternative x y z axies.

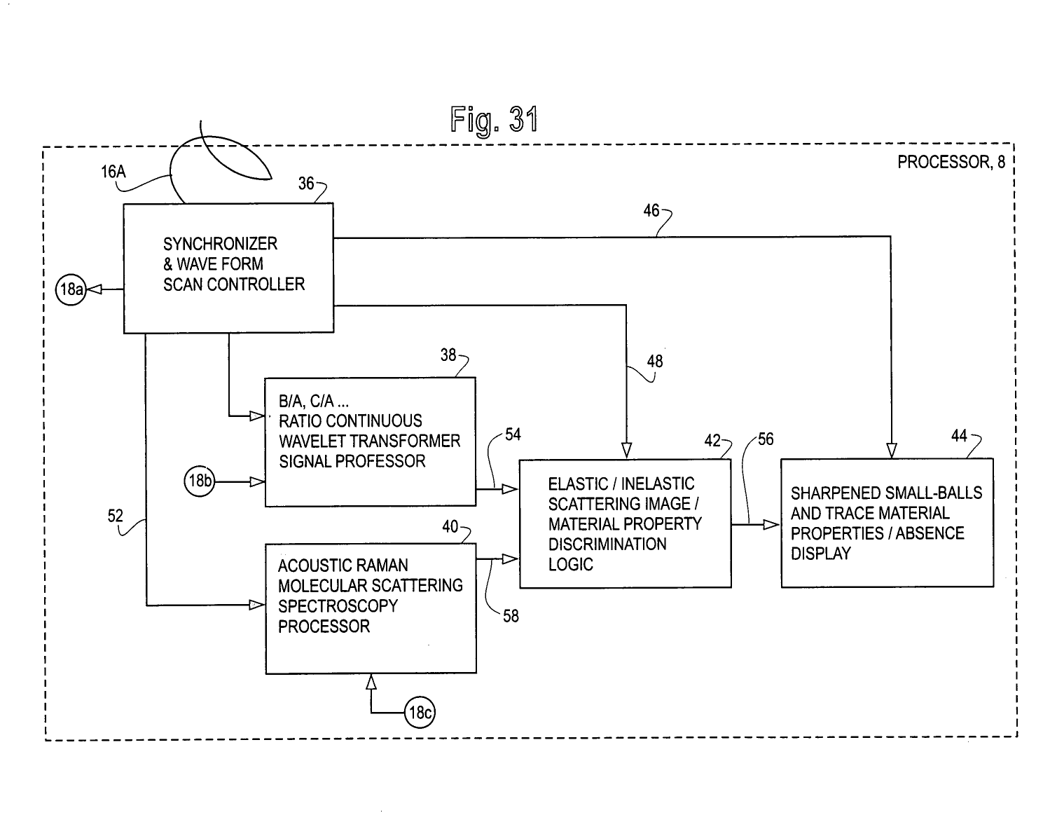

Turning now to FIG. 30, the primary acoustic waveform modulator 20 generates the envelope portion of the Gauss-Rees algorithm in MATLAB-coded software. This software is imbedded into a host computer that also controls other functions of the overall system, such as the synchronization and scan/non-scan controller that feeds into the primary acoustic waveform modulator 20 via link 16. The primary acoustic waveform modulator 20 provides a sinusoidal-carrier-modulated output that drives amplifier 24, discussed in greater detail below.

The primary waveform adaptive equalizer 22 achieves adaptive minimization of the primary acoustic waveform losses presented while penetrating a barrier 5. Equalizer 22 does so through the neutralizing action of an inverted digital filter z-plane form of the sampled data z-plane form of a multiple-path filter whose coefficients are adaptively adjusted through a feed-back error signal input at 16b. This is performed so as to nullify the z-plane representation of the reflections caused by impedance-mismatches at the front and back interfaces of a (possibly metal) barrier which also may be a wall of the container encasing an object 4.

As driven by equalizer 22, amplifier 24 is a standard commercially available large, linear dynamic range digital switching amplifier, such as a National Instruments Model # L-2. Such would provide sufficient power amplification while maintaining linearity precise enough to advert the internal nonlinear distortion from competing with the nonlinear distortion that occurs after projection by an electrical-to-acoustic-pressure transducer into and through the propagation medium 7.

Output from amplifier 24 drives a high source level (SL) projector 26. Projector 26 can, for ultimate nonlinear primary waveform to secondary wavelet conversion efficiency, be sought from available commercial vendors. Projector 26 can be at least 15 decibels in excess of the peak SL given by 149 decibels referenced to one micro-pascal at a distance of one meter as represented by a commercially available AIRMAR AR-30 flexural disc projector used in a secondary acoustic wavelet, scaled SL single-projector concept demonstration.

FIG. 31 illustrates with more detail the processor 8, which comprises a signal processor having logic that can make decisions about the imaged shape and the material properties through both strong elastic and, for example, about 25 to 30 dB weaker inelastic scattering. Both elastic and inelastic scattering jointly occurs when an object 4 is present. It also can provide a decision on the lack of image detail and the absence of a material property of an undesirable object 4 when, indeed, that object is absent.

Processor 8 also can provide adaptive error signals that can be used in at least one, and preferably two feedback loops to control adaptive equalization. The adaptive equalization can: a) can be applied to the transmitter 2 to improve barrier penetration of the Gauss-Rees primary waveform in passing through during transmission and its residual returning back during reception; and also b) can be applied to the receiver 6 to improve barrier penetration of the quasi-Ricker secondary wavelet returning back during reception. Processor 8 also has a synchronizer and waveform scan/non-scan controller 30.

Link 18a sends pulse modulator command signals to tell the transmitter 2 when to transmit during each radial-range cycle and during each “searchlight” beam-scan cycle used to simultaneously image while employing both elastic and inelastic scattering from each image pixel volume to determine the material properties of an object. Link 18a also will not be deactivated during the use of a “floodlighting” beam to facilitate simultaneously interrogating a whole container employing inelastic scattering, to determine that a particular undesirable object 4 is absent.

Links 18b and 18c respectively convey digital signals from the receiver 6 into both the B/A, C/A, . . . , ratio continuous wavelet transform signal processor 38. Using link 18b and Link 18c, the acoustic Raman molecular scattering spectroscopy processor 40 is enabled.

Links 52 and 60 respectively convey digital-control signals to affect radial-range gating and the shifting of beam-scan increments. Links 52 and 60 are used when the “searchlight mode” is used for both elastic and inelastic scattering to determine that the object 4 is present. Link 52 is used to switch over when a “floodlight mode” is only used for inelastic scattering to determine that an undesirable object 4 is absent.

Signal processor 38 performs Continuous Wavelet Transform (CWT) analysis, which involves a forming a parameter search using a replica correlation integral, under the synchronization and control affected through Links 52 and 60. This approach is based upon a time delayed and scaled time version of a mother wavelet that has been purposely nonlinearly distorted to reflect different values of B/A, C/A, . . . , ratio material nonlinear-distortion coefficients so that a gradient or any other search method can ascertain the values of B/A and C/A within each 3-D volumetric pixel and the digital result conveyed for Link 54.

Likewise, spectroscopy processor 40 performs Mellin Transform analysis in a signal processor that involves acoustic Raman molecular scattering spectroscopy to interrogate the inelastic scattering. The inelastic scattering is due to material absorption of phonons that produces a Raman frequency downshift and the 5 dB or so weaker material radiation of phonons that produces an acoustic nonlinear spectroscopy signature. This signature allows material-property discrimination based upon a match of the known Raman scattering library signature. The inelastic scattering received and processed within the signal processing of spectoscopy processor 40 is driven by secondary wavelet “impulse” signals derived from Link 18c from the receiver 6 and the digital results conveyed over Link 58.

Link 46 synchronizes and controls the functions performed in elastic and inelastic scattering/image and material-properties discrimination logic of Logic 42.

Logic 42 makes definitive decisions for feeding the display 44 over Link 56. That is, both links 54 and 56 respectively feed the elastic/inelastic scattered, image/material-property discrimination logic of logic 42 with both small-bulk B/A, C/A, . . . , ratio elastic scattering material-property signature matches and the spectroscopic inelastic material-property signature matches obtained in seeking an object present within any volumetric pixel determined by its radial-range dimension and two cross-range “searchlight-beam” scanned dimensions, as well as the case when inelastic scattering “floodlight-beam” interrogation with no range gating and scanning is used to ascertain that an undesirable object inelastic material-property signature is absent. In this regard, consider as another embodiment the use of a neural net approach for Logic 42, and incorporate by reference U.S. Pat. No. 5,634,087, titled “Rapidly Trainable Neural Tree Network,” issued May 27, 1997, and naming as inventors Richard J. Mammone, et. al.

Link 48 is used to synchronize and control functions of the image shape, small bulk and trace object 4 sought-after material properties present and trace object unwanted material properties absent colored monitor display 44.

Display 44 receives the definitive decisions made by the logic 42 feed via link 56 into the colored monitor display 44 as synchronized and controlled by link 48. Other output devices are also suitable means for formatting a presentation of the results to a human, as well as to apply symbols to indicate the potentially present and absent unwanted materials.

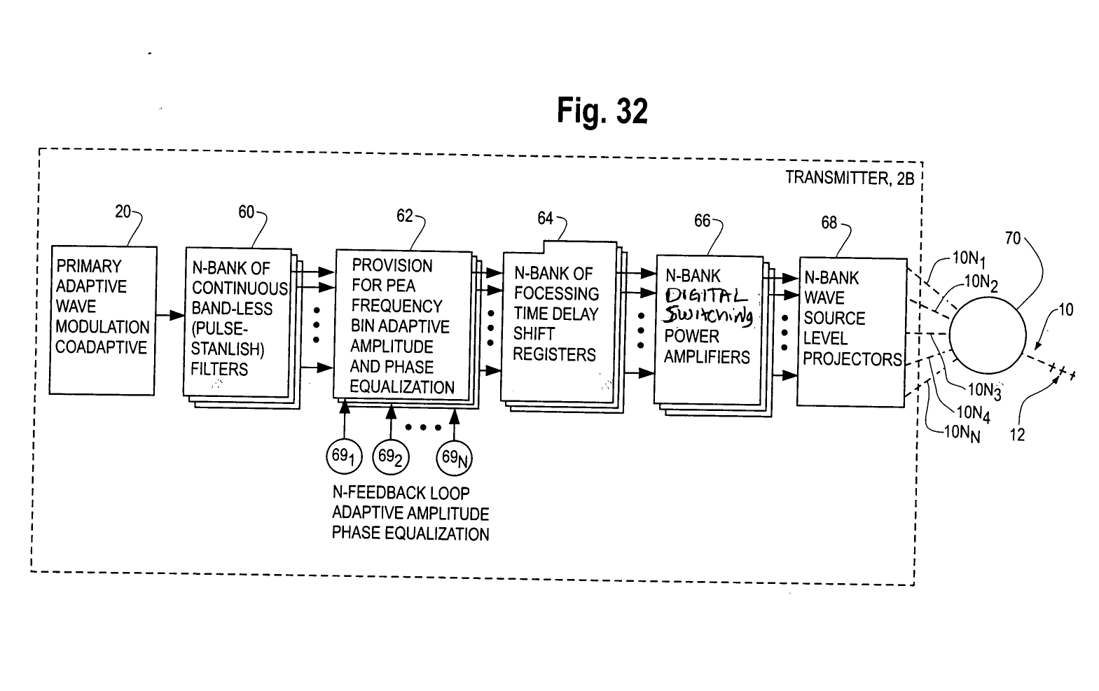

Turning now to FIG. 32, another embodiment of the transmitter 2 is illustrated. Essentially, this variant of transmitter 2, having components suitable in the place of computer 20 of FIG. 29 that also is embedded into the transmitter 2 of FIG. 28, etc., re-designated as transmitter 2B of FIG. 32. FIG. 32 illustrates a multiple-projector array embodiment. In such an embodiment, it is possible to apply the transmitter-side adaptive equalization of the Gauss-Rees primary waveform as a feedback-corrected amplitude and phase adjustment on a per frequency bin basis due to the sub-division of this waveform into multiple, contiguous but non-overlapping frequency bins in filters 60. These filters 60 correspond to the plurality of the projectors used to populate a transmitter transducer array of N-projectors in Box 68.

Link 59 provides for an analogue waveform transfer of the Gauss-Rees primary waveform—implicitly these are N-multiple links (e.g., 59₁ through 59_{N} implicit in link 59) throughout FIGS. 32, 33 and 34—to a bank of contiguous analogue band-pass filters (BPFs), with a digital waveform transfer Link 59 into digital realizations of the bank of Band-Pass Filters (BPFs) 60 being a preferred alternative.

More particularly, BPFs 60 comprise an N-bank of contiguous but non-overlapping frequency BPFs to facilitate sub-dividing the Gauss-Rees primary waveform into N-coherently phase-locked channels as a synthetic-spectrum decomposition for driving a transmitter transducer array comprised of N-projectors. This approach permits each projector to have to only handle a 1/N sub-division of the total Gauss-Rees acoustic energy of the ultimately reconstructed primary wave. The sub-divided energy appears in a pulse that is “stretched” by its corresponding BPF and whose duration is increased and peak-pressure level decreased relative to what would exist if this pulse “stretching” had not occurred. This approach thus enables an increase of each individually transmitted sub-divided Gauss-Rees acoustic primary waveform. It consequently results in an even higher acoustic source level (approaching and even exceeding the desired critical shock source level) after focused reconstruction of the N-channels around the mid-near field of the Rayleigh near-field/far-field transition of this transmitter transducer array. Note that distance is given in consistent units by the area of this array divided by the wavelength of the primary waveform.

Link 61 digitally couples N-BPFs 60's “stretched” pulses into a corresponding N-set of amplitude and phase equalizers 69. Because the equalizers 69 are applied on an N-frequency bin basis, there is a frequency domain way of affecting the time domain de-convolution process for adaptively improving barrier penetration as otherwise applied on a single basis. For example, on the transmitter 2 side of the single projector approach and the receiver 6 side of FIG. 28, there is a receiver and its equalizer that is also common to the transmitter 2B for FIG. 32.

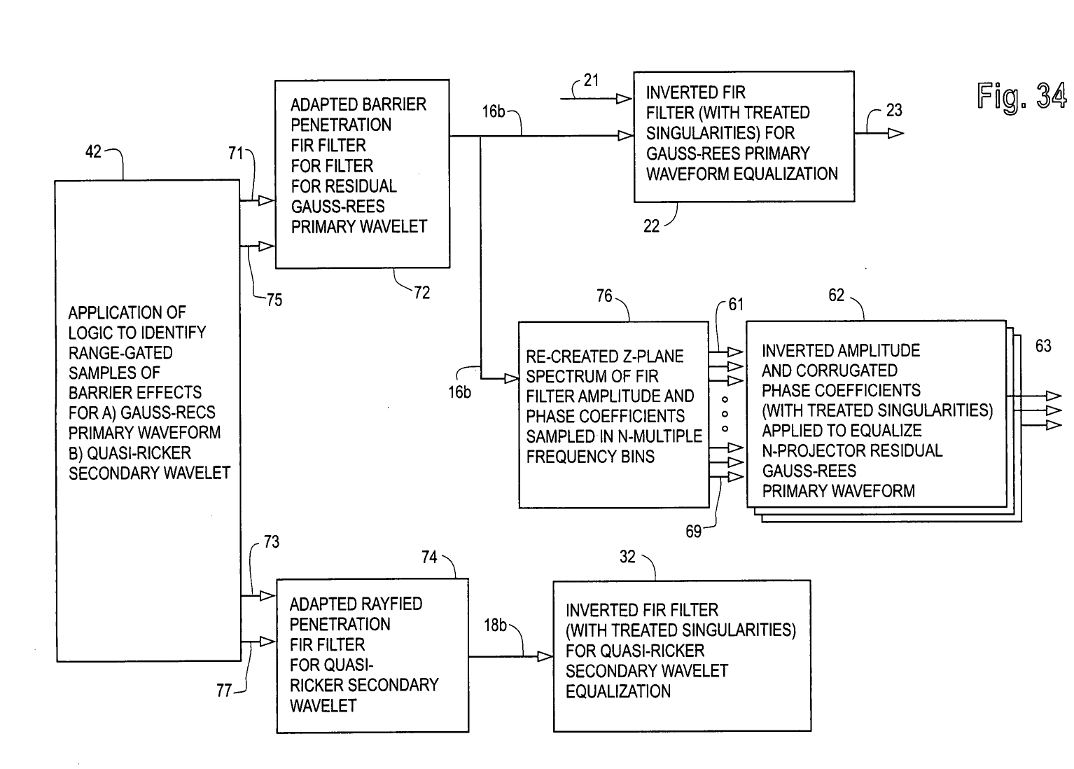

There is a per N-frequency bin adaptive amplitude and phase equalization unit 62 to improve barrier 5 penetration. In each, amplitude and phase adjustment is driven by its own frequency-domain adaptive feedback loop (each involving its own link 69₁, through 69_{N} of FIG. 34) which is a sub-division method for using a per N-frequency bin amplitude and phase. This approach can be used instead of the N-time-delay taps used in an adaptive feedback loop for a single channel implementation covering the total frequency band by a de-convolution approach. Instead, it computes the complex-number weights for each time-delay tap before combining them and adapting each weight according to an adaptive error criterion applied to this summation to: a) first form a sampled data z-plane version of the interference response due to barrier front-face and rear-face multiple reflections caused by impedance mismatches; then b) also invert this z-plane filter response (while handling consequential related improper-integral discontinuities accordingly) to form a z-plane equalization response to nullify the impact of multiple reflections on barrier penetration this way and through its frequency-domain N-frequency bin decomposition.

The digital N-signal stream (perhaps equalization corrected in adaptive amplitude and phase equalization unit 62 when a barrier 5 has to be penetrated) is communicated by link 63 to an N-bank of time-delay shift registers 64.

Shift registers 64 are pre-adjusted to focus the N-bank of synthetic-spectrum digitized waveforms from filters 60 (perhaps passed through the N-channel adaptive amplitude and phase equalization unit 62) used to drive the time-delay registration to bring about focused Gauss-Rees acoustic primary waveform reconstruction in a focal region centered around a focal point positioned at a “stand-off” distance located approximately at the mid-point between the Rayleigh near-field/far-field transition region.

The time registered digital N-signal stream is communicated by link 65 to an N-bank of digital switching power amplifiers 66. The N-digital switching power amplifiers in Box 66 are a plurality of the type of single digital switching power amplifiers 24 are en effect a bank of such amplifies 24 in FIG. 29 but, instead, each handle one of the sub-divided “stretched” pulses formed by the N-bank BPFs 60.

The power amplified N-digital signals are communicated by link 67 into a transmitting transducer array of N-projectors 68. The array of transmitting transducers has N-projectors each similar to the single projector 26 of FIG. 29. However, in this embodiment, each of these projectors 29 is less stressed for source level by virtue of the amplification due to the reconstruction action of the coherent addition implicit in the synthetic-spectrum focused array of N-projectors. This means that more modest projectors 29 can be used to achieve the same source level as a single projector but with the advantage of a significant “stand-off” distance capability. While an alternative is to use existing commercial projectors to achieve a far higher source level than hitherto possible, i.e., potential for extension beyond the critical shock source level into the quasi-saturated region. Depending upon how far this virtual source level is extended before a cataclysmic dive in conversion efficiency occurs, e.g., an addition of 10 dB in acoustic secondary wavelet source level can be extracted. The extraction can be carried out, for example, by squaring the envelope of the Gauss-Rees acoustic primary waveform to compensate for the change over from the nonlinear effect producing the self-demodulated acoustic secondary wavelet being proportional to the time derivative of the absolute value of the acoustic-pressure variations of a primary waveform in the quasi-saturated region as opposed to the currently exploited absolute value squared for its non-saturated counterpart. That is, when the acoustic primary waveform source level is equal to or less than the critical shock source level.

The plurality of Links 10₁ through 10_{N} are each similar to link 10 of FIG. 28 except that the generally lower source level of each “stretched” pulse forestalls the dominant nonlinear interaction until the Gauss-Rees acoustic primary waveform is reconstructed in the focal region 70.

The focal region 70 effectively acts as a very strong virtual source of acoustic energy forestalled at some considerable “stand-off” distance (as described in association with filters 60 and shift registers 64) from its original array face. An embodiment using a focal region 70 facilitates a much higher source level Gauss-Rees acoustic primary waveform on a travelling wave front that is propagating through the near-field/far-field transition that occurs close to the focal region whose cross-sectional area is much smaller than the transmitting transducer array of N-projectors 68.

The progression of a the very strong virtual acoustic source level that forms in the focal region 70 is the same as described in relation to acoustic waveforms propagating along 10 and 12 of FIG. 28 with the exception that this very strong virtual source level can be adjusted to operate in the quasi-saturated region. This region extends as much as, say, 10 dB beyond the critical shock source level of the nonlinear interaction generated in the medium before a cataclysmic dive in conversion efficiency occurs (as discussed above in the context of projectors 68 along with considerations about the associated change in the conversion transfer function).

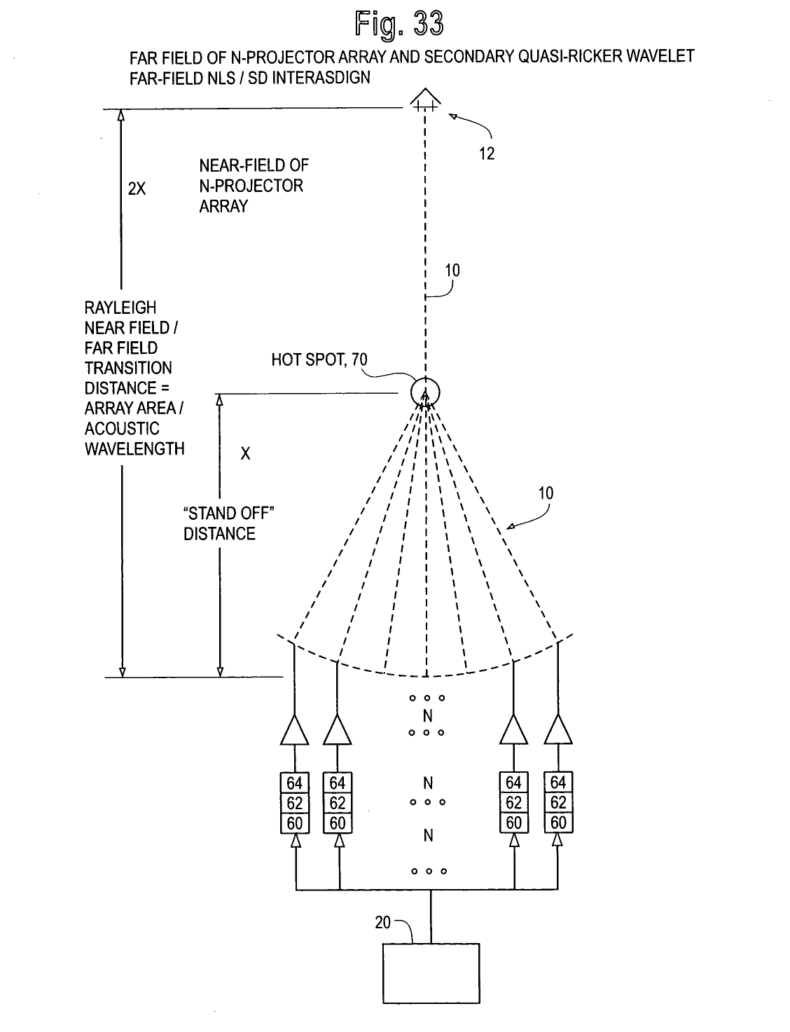

Note that FIG. 32 has a companion configuration graphic overview shown in FIG. 33. FIG. 33 illustrates the Rayleigh near-field/far-field transition regions of the transmitter transducer array of N-projectors 68. FIG. 33 illustrates the synthetic spectrum focussed “hot spot” or focal region 70 forestalling embodiment. This embodiment can use a concave (i.e., parabolic) array projectors 68 in connection with respective power amplifiers 66, etc. as shown in more detail in FIG. 32.

Turning now to FIG. 34, there is illustrated an additional part of the action of the signal-processing portion of the processor 8, the logic 42 of FIG. 31 also has a preliminary measure of both the position through radial-range gating and the logic-derived identity of the presence of a barrier 5 that may be used to cull out an identified barrier-reflection sample of reflections as received from a residual of the Gauss-Rees acoustic primary waveform fed-out on link 71 and an acoustic secondary quazi-Ricker wavelet sample fed-out on link 73. Both are composites of signal returns respectively: in the former case reflected from the front-face of a barrier 5 interfering with one from the back-face of the barrier 5; and in the latter case passed through the barrier 5 in the opposite direction.

The radial-range gated and logic-derived identified sample of the barrier reflected residual Gauss-Rees acoustic primary waveform is transferred to filter 72 for the purpose of adaptively creating a z-plane Finite Impulse Response (FIR) filter representation of the multi-path reflections created by the front and back face impedance mismatches with the propagation medium. At filter 72, the sample provided by link 71 is passed through a FIR filter whose unknown coefficient is subjected to an adaptive-feedback loop error signal obtained by taking the difference between the a standard Gauss-Rees electrical primary waveform stored in a digital memory—as transferred via link 75. The FIR filter output signal is used to form an error signal that is used as a feedback control on the FIR-filter coefficient; which FIR-filter coefficients are fed to equalizer 22 of FIG. 29 via link 16b. The foregoing is carried out such that an inverted FIR filter is created and applied (while also handling the singularities using a treatment similar to one utilized to remove improper conditioning of integrals) to adaptively pre-nullify the expected barrier 5 transfer-function effect on the Gauss-Rees electrical primary waveform handled at equalizer 22. The communicating is carried out by link 21. After this adaptive pre-correction exits equalizer 22 by link 23 (as shown at equalizer 22 of FIG. 29). Link 16b also enters N-multiple frequency bins 76, wherein the z-plane FIR-filter response is sub-divided into the N-frequency sub-bands matching filters 60 of FIG. 32. The resultant N (inverted) amplitude and (conjugated) phase coefficients are transferred over the N-coefficient is communicated by links 69₁ through 69_{N} and applied as derived amplitude and phase equalization coefficients in equalization 62 of FIG. 32 (while also handling the singularities using a treatment similar to one utilized to remove improper conditioning of integrals). This approach adaptively pre-nullifies the barrier 5 transfer-function effect incurred in the N-multiple-projector embodiment.

The radial-range gated and logic-derived identified sample of the quasi-Ricker acoustic secondary wavelet that has passed through the barrier is transferred by link 73 to FIR filter 74 for the purpose of adaptively creating a z-plane Finite Impulse Response (FIR) filter representation of the multi-path reflections created by the front and back face impedance mismatches with the propagation medium. In FIR filter 74, the sample provided by link 73 is passed through a FIR filter whose unknown coefficient is subjected to an adaptive-feedback loop error signal obtained by taking the difference between the a standard quazi-Ricker electrical secondary wavelet stored in a digital memory—as transferred via link 77. The FIR filter 74 output signal forms an error signal that is used as a feedback control on the FIR-filter coefficient. The FIR-filter coefficients are fed to an inverted equalization digital filter 32 of FIG. 30 via link 18b.

An inverted FIR filter is created and applied (while also handling the singularities using a treatment similar to one utilized to remove improper conditioning of integrals) to adaptively nullify the expected barrier transfer-function effect on the electrical secondary wavelet entering amplifier 32 via link 31, and after this adaptive correction, the signal exits amplifier 32 via link 33 as shown in amplifier 32 of FIG. 30.

In conclusion, in view of the foregoing, the invention herein embraces the newly discovered Gauss-Rees waveform and its applications. The applications are encompassing and permit accomplishing what has not been accomplished before, such as interrogating an object in a container without causing radiative damage risk to people and animals. The invention extends to the machines for carrying out the application(s), articles of manufacture, and methods for making and using the same.

Viewed for brevity in the case of a method, one aspect of the invention can be viewed as a method for identifying an object, the object can really be any object, but one standard definition of an object is a thing that forms an element of or constitutes the subject matter of an investigation or science. Representative objects, by no means comprehensive, include a weapon, such as a firearm, knife, box cutter, or other weapon, ore on a grander scale, a weapon system, a radioactive substance, an explosive or incendiary or flammable composition, a chemical, a biological material, a drug—really any object prohibited by law.

In embodiments such as those discussed herein, the object can be miniscule in size, such as a molecule, an element, or an isotope, in ever more preferable ranges of less than one in 10,000, less than one in 1,000, less than one in 100,000, less than one in 1 million, less than one in 10 million, less than one in 100 million, less than one in 1 billion, less than one in 10 billion, less than one in 10 billion, and less than one in 1 trillion; or the object can be on a grand scale, such as in distinguishing a military target from a non-target or a missile or projectile or bomb from another or, say, a aircraft. That is to say, the step of directing the primary acoustic waveform at the object includes directing the pulse at the object concealed in a container, e.g., the object can be concealed in one way or another, e.g., from an isotope in a solid to a weapon in luggage.

This can include directing the pulse at object concealed in a piece of luggage, an object concealed in a cargo container, in a motor vehicle (e.g., a motor vehicle including a truck, an automobile, a motor vehicle other than a truck and other than a car, a water craft, an aircraft, a missile (or a projectile or bomb), as well as an object concealed in a nuclear reactor, such as leaking fuel, or an object concealed on or in a human. The object can be concealed in a building, underground, under water, in a metal container such as a container having a thickness of at least ¼ of an inch, or through a thickness of at least ⅛ of an inch.

In saving lives from mines, the invention encompasses identifying such objects as a land mine or an underwater mine (of any type), but also such objects as an archeological site, or a pipe including a well head or forgotten oil equipment. Indeed, the object can be an underground composition such as a hydrocarbon or an indicator of a composition, such as a dome indicating a likely hydrocarbon presence, i.e., an indicator of a hydrocarbon.

In any of the embodiments, The method can include the steps of: directing a primary acoustic waveform at the object to produce a nonlinear acoustic effect; receiving a secondary wavelet produced by the nonlinear effect; and processing the received secondary wavelet in identifying the object.

In any of the embodiments, the step of identifying the object can include forming an image of the object and or identifying a material, for example, by comparing the received secondary wavelet with a standard. The standard can be obtained by comparing the received secondary wavelet with a secondary wavelet produced by a nonlinear acoustic effect from air, water, and/or land. Indeed, in any of the embodiments, the identifying of the object can includes forming a land seismographic stratification image, a marine water stratification image.

In any of the embodiments, the step of receiving can include receiving the secondary wavelet as scattered acoustic energy, as backscattered acoustic energy, as oblique scattered acoustic energy, and/or as forward scattered acoustic energy. Likewise, any embodiment can include receiving the secondary wavelet at more than one receiver, and the processing the received secondary wavelet in identifying the object can include forming a tomographic image, usually preferably a three dimensional tomographic image.

Again in any of the embodiments, the step of directing can include passing the primary acoustic waveform through a wall of a container (e.g., or other barrier) to reach the object. Preferably in any embodiment, the step of directing is carried out with the primary acoustic waveform having a beam width that does not increase before the receiving, and even more preferably, with the primary acoustic waveform having a beam width that decreases before the receiving.

In any of the embodiments, one can also include any one or more of the steps of: (a) shaping the primary acoustic waveform into a Gausian envelope that is time differentiated with a direct current offset sufficient that none of the envelope is negative; (b) using the envelope to amplitude modulate a sinusoidal carrier wave; and/or (c) gating the amplitude modulated sinusoidal carrier wave with a unitary pulse.

Likewise, any of the embodiments, can further include any one or more of the steps of: (a) standardizing the secondary wavelet of the primary wave form by the nonlinear acoustic effect that time differentiates the envelope in a projector's far field; (b) discriminating a distortion of the secondary wavelet caused by the object; (c) characterizing the distortion in the identifying of the object; and/or (d) separating elastic scattering and inelastic scattering.

Similarly, in any of the embodiments, the step of receiving the secondary wavelet can be carried out with a wavelet having no recognizable carrier wave. And in any of the embodiments, the step of receiving can include discerning the nonlinear effect as associated with the elastic scattering and/or discerning a ratio of a nonlinear coefficient to a bulk modulus; more so the step of discerning can be carried out with the ratio being a ratio of a first order nonlinear coefficient to a bulk modulus, and wherein the step of discerning can also include discerning a second ratio of a second order nonlinear coefficient to the bulk modulus. Similarly, the step of discerning can include comparing the secondary wavelet with a wavelet standardized to air, water, and/or land.

In any of the embodiments, the step of receiving can include discerning the nonlinear effect as associated with the inelastic scattering; and/or the step of performing can include spectroscopic analysis of nonlinear responses excited by the secondary wavelet. Preferred ranges can include carrying out the step of directing with the primary acoustic waveform having a frequency in a range of 40-80 KHz; 20-40 KHz; 25-30 KHz; 2-4 KHz; 909-1,091 Hz, depending on whether the embodiment involves air, land, and water.

Preferred ranges can include selecting the scaling of the Gauss-Rees primary waveform to generate a secondary wavelet having a frequency in a range of: 2.5-7.5 Hz; more than 0 to 40 kz; more than 0 to 20 kz; more than 0 to 2 kz; more than 91 to 273 Hz, again depending on whether the embodiment involves air, land, or water.

In any embodiment, the step of identifying can include determining the object is present or not present.

The receiver 6 can be located in any configuration compatible with what has been set out above. For example, the receiver 6 can be located for directing from a hovercraft, a drone or robot, a buoy, a hand held device, a toll booth device, a passage-way device with the receiver 6/transmitter 2 located on any axis, for example, for directing from a vertical passage-way device, from a horizontal passage-way device, or from both. Any embodiment can include a configuration for moving a device directing the primary acoustic waveform, with respect to the object; moving the object with respect to a device directing the primary acoustic waveform; and/or moving both the object and a device directing the primary acoustic waveform, and adjusting for relative movement. This is a matter of compensating for the movement in the application of interest.

Variations for and of the different embodiments can also be seen in handling of the output, for example, the step of processing can include processing the received secondary wavelet to form pixels, preferably three-dimensional pixels, and more preferably including the step of identifying the object in each of a plurality of the pixels.

A definite advantage for any of the embodiments is to carry out the invention so that the step of producing the primary acoustic wave form with a transducer that is not in contact with a container of the object, and while in some embodiments, it is acceptable for the step of directing the primary acoustic waveform to be carried out with only one projector transmitting in a far field of the projector, it is often preferable that the step of directing the primary acoustic waveform is carried out with a plurality of projectors transmitting in a far field of an array formed by the projectors.

In any of the embodiments, the step of directing can be carried out with contiguous filters, each filter having a unique pass band and corresponding to a projector in an array; and preferably the step of directing is carried out with contiguous filters, each filter having a unique pass band and corresponding to a projector in an array, and further including the step of forming a focal region of coherent reconstruction of amplifying the primary acoustic waveform.

In any of the embodiments the step of receiving can include the step of equalizing an impedance mismatch caused by a wall 5 to a container of the object 4; the step of directing includes the step of equalizing the impedance mismatch; and preferably the steps of directing and receiving both include adapting feedback to carry the steps of equalizing.

The foregoing discussion of the figures and context for the figures contains many details for the purpose of teaching how to make and how to use several embodiments of the invention. However, the inventor respectfully requests that the details of an embodiment or its context should not be construed as limitations: these are teachings by example, not restrictions. The exemplifications of various preferred embodiments discussed herein are only to illustrate the broader scope of the invention, which can be used in different adaptations depending on the use intend use. Many other variations are possible within the breadth of the invention as a whole. Thus, the scope of the invention should be determined by the claims and their legal equivalents, rather than by the particular representative embodiments and other examples and discussion above.

I claim:

1. A method for identifying an object, the method including the steps of:
directing a primary acoustic waveform at the object to produce a nonlinear acoustic effect;
receiving a secondary wavelet produced by the nonlinear effect; and
processing the received secondary wavelet in identifying the object.

2. The method of claim 1, wherein the step of identifying the object includes forming an image of the object.

3. The method of claim 1, wherein the step of identifying the object includes identifying a material by comparing the received secondary wavelet with a standard.

4. The method of claim 1, wherein the step of identifying the object includes forming an image and identifying a material by comparing the received secondary wavelet with a secondary wavelet produced by a nonlinear acoustic effect from air.

5. The method of claim 1, wherein the step of identifying the object includes forming an image and identifying a material by comparing the received secondary wavelet with a secondary wavelet produced by a nonlinear acoustic effect from water.

6. The method of claim 1, wherein the step of identifying the object includes forming an image and identifying a material by comparing the received secondary wavelet with a secondary wavelet produced by a nonlinear acoustic effect from land.

7. The method of claim 1, wherein the step of receiving includes receiving the secondary wavelet as scattered acoustic energy.

8. The method of claim 1, wherein the step of receiving includes receiving the secondary wavelet as backscattered acoustic energy.

9. The method of claim 1, wherein the step of receiving includes receiving the secondary wavelet as oblique scattered acoustic energy.

10. The method of claim 1, wherein the step of receiving includes receiving the secondary wavelet as forward scattered acoustic energy.

11. The method of claim 1, wherein the step of receiving includes receiving the secondary wavelet at more than one receiver, and wherein the step of processing the received secondary wavelet in identifying the object includes forming a tomographic image.

12. The method of claim 11, wherein the step of forming a tomographic image includes forming a three dimensional tomographic image.

13. The method of claim 1, wherein the step of directing includes passing the primary acoustic waveform through a wall of a container to reach the object.

14. The method of claim 1, wherein the step of directing is carried out with the primary acoustic waveform having a beam width that does not increase before the receiving.

15. The method of claim 1, wherein the step of directing is carried out with the primary acoustic waveform having a beam width that decreases before the receiving.

16. The method of claim 1, wherein the step of identifying the object includes identifying a weapon.

17. The method of claim 1, wherein the step of identifying the object includes identifying a radioactive substance.

18. The method of claim 1, wherein the step of identifying the object includes identifying an explosive.

19. The method of claim 1, wherein the step of identifying the object includes identifying a biological material.

20. The method of claim 1, wherein the biological material has a concentration of less than one in 10,000.

21. The method of claim 1, wherein the biological material has a concentration of less than one in 1,000.

22. The method of claim 1, wherein the biological material has a concentration of less than one in 100,000.

23. The method of claim 1, wherein the biological material has a concentration of less than one in 1 million.

24. The method of claim 1, wherein the biological material has a concentration of less than one in 10 million.

25. The method of claim 1, wherein the biological material has a concentration of less than one in 100 million.

26. The method of claim 1, wherein the biological material has a concentration of less than one in 1 billion.

27. The method of claim 1, wherein the biological material has a concentration of less than one in 10 billion.

28. The method of claim 1, wherein the biological material has a concentration of less than one in 10 billion.

29. The method of claim 1, wherein the biological material has a concentration of less than one in 1 trillion.

30. The method of claim 1, wherein the step of identifying the object includes identifying a chemical.

31. The method of claim 1, wherein the step of identifying the object includes identifying a drug.

32. The method of claim 1, wherein the step of identifying the object includes identifying the object one of a plurality of objects prohibited by law.

33. The method of claim 1, wherein the step of identifying the object includes identifying a land mine.

34. The method of claim 1, wherein the step of identifying the object includes identifying an underwater mine.

35. The method of claim 1, wherein the step of identifying the object includes identifying an archeological site.

36. The method of claim 1, wherein the step of identifying the object includes identifying a pipe.

37. The method of claim 1, wherein the step of identifying the object includes identifying an underground composition.

38. The method of claim 1, wherein the step of identifying the object includes identifying an indicator of a composition.

39. The method of claim 1, wherein the step of identifying the object includes identifying an indicator of a hydrocarbon.

40. The method of claim 1, wherein the step of identifying a hydrocarbon.

41. The method of claim 1, wherein the step of identifying the object includes forming a land seismographic stratification image.

42. The method of claim 1, wherein the step of identifying the object includes forming a marine water stratification image.

43. The method of claim 1, wherein the step of directing the primary acoustic waveform at the object includes directing the pulse at object concealed in a container.

44. The method of claim 1, wherein the step of directing the primary acoustic waveform at the object includes directing the pulse at object concealed in a piece of luggage.

45. The method of claim 1, wherein the step of directing the primary acoustic waveform at the object includes directing the pulse at object concealed in a cargo container.

46. The method of claim 1, wherein the step of directing the primary acoustic waveform at the object includes directing the pulse at object concealed in a motor vehicle.

47. The method of claim 46, wherein the step of directing the primary acoustic waveform at the object is carried out with the motor vehicle including a truck.

48. The method of claim 46, wherein the step of directing the primary acoustic waveform at the object is carried out with the motor vehicle including an automobile.

49. The method of claim 46, wherein the step of directing the primary acoustic waveform at the object is carried out with the motor vehicle other than a truck and other than a car.

50. The method of claim 1, wherein the step of directing the primary acoustic waveform at the object includes directing the pulse at object concealed in a water craft.

51. The method of claim 1, wherein the step of directing the primary acoustic waveform at the object includes directing the pulse at object concealed in an aircraft.

52. The method of claim 1, wherein the step of directing the primary acoustic waveform at the object includes directing the pulse at object concealed in a nuclear reactor.

53. The method of claim 1, wherein the step of directing the primary acoustic waveform at the object includes directing the pulse at object concealed on a human.

54. The method of claim 1, wherein the step of directing the primary acoustic waveform at the object includes directing the pulse at object concealed in a human.

55. The method of claim 1, wherein the step of directing the primary acoustic waveform at the object includes directing the pulse at object concealed in a building.

56. The method of claim 1, wherein the step of directing the primary acoustic waveform at the object includes directing the pulse at the object concealed underground.

57. The method of claim 1, wherein the step of directing the primary acoustic waveform at the object includes directing the pulse at object concealed under water.

58. The method of claim 1, wherein the step of directing the primary acoustic waveform at the object includes directing the pulse at object concealed in a metal container.

59. The method of claim 1, wherein the step of directing the primary acoustic waveform at the object includes directing the pulse at object concealed in a container having a thickness of at least ¼ of an inch.

60. The method of claim 1, wherein the step of directing the primary acoustic waveform at the object includes directing the pulse at object concealed in a container having a thickness of at least ⅛ of an inch.

61. The method of claim 1, further including the step of shaping the primary acoustic waveform into a Gausian envelope that is time differentiated with a direct current offset sufficient that none of the envelope is negative.

62. The method of claim 61, further including the step of using the envelope to amplitude modulate a sinusoidal carrier wave.

63. The method of claim 62, further including the step of gating the amplitude modulated sinusoidal carrier wave with a unitary pulse.

64. The method of claim 61, further including the steps of:
standardizing the secondary wavelet of the primary wave form by the nonlinear acoustic effect that time differentiates the envelope in a projector's far field.

65. The method of claim 64, wherein the step of processing includes discriminating a distortion of the secondary wavelet caused by the object.

66. The method of claim 65, wherein the step of processing includes characterizing the distortion in the identifying of the object.

67. The method of claim 1, wherein the step of processing includes separating elastic scattering and inelastic scattering.

68. The method of claim 1, wherein the step of receiving the secondary wavelet is carried out with a wavelet having no recognizable carrier wave.

69. The method of claim 1, wherein the step of receiving includes discerning the nonlinear effect as associated with the elastic scattering.

70. The method of claim 69, wherein the step of discerning includes discerning a ratio of a nonlinear coefficient to a bulk modulus.

71. The method of claim 69, wherein the step of discerning is carried out with the ratio being a ratio of a first order nonlinear coefficient to a bulk modulus, and wherein the step of discerning also includes discerning a second ratio of a second order nonlinear coefficient to the bulk modulus.

72. The method of claim 69, wherein the step of discerning includes comparing the secondary wavelet with a wavelet standardized to air.

73. The method of claim 69, wherein the step of discerning includes comparing the secondary wavelet with a wavelet standardized to water.

74. The method of claim 69, wherein the step of discerning includes comparing the secondary wavelet with a wavelet standardized to land.

75. The method of claim 1, wherein the step of receiving includes discerning the nonlinear effect as associated with the inelastic scattering.

76. The method of claim 75, further including the step of performing spectroscopic analysis of nonlinear responses excited by the secondary wavelet.

77. The method of claim 1, wherein the step of identifying includes determining the object is present.

78. The method of claim 1, wherein the step of identifying includes determining the object is not present.

79. The method of claim 1, wherein the step of directing includes directing from a hover craft.

80. The method of claim 1, wherein the step of directing includes directing from a drone.

81. The method of claim 1, wherein the step of directing includes directing from a buoy.

82. The method of claim 1, wherein the step of directing includes directing from a hand held device.

83. The method of claim 1, wherein the step of directing includes directing from a toll booth device.

84. The method of claim 1, wherein the step of directing includes directing from a passage-way device.

85. The method of claim 1, wherein the step of directing includes directing from a vertical passage-way device.

86. The method of claim 1, wherein the step of directing includes directing from a horizontal passage-way device.

87. The method of claim 1, further including the step of moving a device directing the primary acoustic waveform, with respect to the object.

88. The method of claim 1, further including the step of moving the object with respect to a device directing the primary acoustic waveform.

89. The method of claim 1, further including the step of moving both the object and a device directing the primary acoustic waveform, and adjusting for relative movement.

90. The method of claim 1, wherein the step of directing is carried out with the primary acoustic waveform having a frequency in a range of 40-80 KHz.

91. The method of claim 1, wherein the step of directing is carried out with the primary acoustic waveform having a frequency in a range of 20-40 KHz.

92. The method of claim 1, wherein the step of directing is carried out with the primary acoustic waveform having a frequency in a range of 25-30 KHz.

93. The method of claim 1, wherein the step of directing is carried out with the primary acoustic waveform having a frequency in a range of 2-4 KHz.

94. The method of claim 1, wherein the step of directing is carried out with the primary acoustic waveform having a frequency in a range of 909-1,091 Hz.

95. The method of claim 1, wherein the step of directing is carried out with the secondary wavelet having a frequency in a range of 2.5-7.5 Hz.

96. The method of claim 1, wherein the step of receiving is carried out with the secondary wavelet having a wavelength in a range of more than 0 to 40 kz.

97. The method of claim 1, wherein the step of receiving is carried out with the secondary wavelet having bandwidth in a range of more than 0 to 20 kz.

98. The method of claim 1, wherein the step of receiving is carried out with the secondary wavelet having bandwidth in a range of more than 0 to 2 kz.

99. The method of claim 1, wherein the step of receiving is carried out with the secondary wavelet having bandwidth in a range of more than 91 to 273 Hz.

100. The method of claim 1, wherein the step of processing includes processing the received secondary wavelet to form pixels.

101. The method of claim 1, wherein the step of processing includes processing the received secondary wavelet to form three-dimensional pixels.

102. The method of claim 101, further including the step of identifying the object in each of a plurality of the pixels.

103. The method of claim 1, further including the step of producing the primary acoustic wave form with a transducer that is not in contact with a container of the object.

104. The method of claim 1, wherein the step of directing the primary acoustic waveform is carried out with only one projector transmitting in a far field of the projector.

105. The method of claim 1, wherein the step of directing the primary acoustic waveform is carried out with a plurality of projectors transmitting in a far field of an array formed by the projectors.

106. The method of claim 1, wherein the step of directing is carried out with contiguous filters, each filter having a unique pass band and corresponding to a projector in an array.

107. The method of claim 1, wherein the step of directing is carried out with contiguous filters, each filter having a unique pass band and corresponding to a projector in an array, and further including the step of:
forming a focal region of coherent reconstruction of amplifying the primary acoustic waveform.

108. The method of claim 107, wherein the step of receiving includes the step of equalizing an impedance mismatch caused by a wall to a container of the object.

109. The method of claim 108, wherein the step of directing includes the step of equalizing the impedance mismatch.

110. The method of claim 109, wherein the steps of directing and receiving include adapting feedback to carry the steps of equalizing.

111. The method of claim 1, wherein the object is an element.

112. The method of claim 1, wherein the object is a molecule.

113. The method of claim 1, wherein the object is an isotope.
